(19) United States
(12) Patent Application Publication
(10) Pub. No.: US 2019/0187266 A1
(43) Pub. Date: Jun. 20, 2019

(54) OBJECT DETECTION APPARATUS AND OBJECT DETECTION METHOD

(71) Applicant: NEC Corporation, Minato-ku, Tokyo (JP)

(72) Inventor: Shingo YAMANOUCHI, Tokyo (JP)

(73) Assignee: NEC Corporation, Minato-ku, Tokyo (JP)

(21) Appl. No.: 16/323,031

(22) PCT Filed: Aug. 5, 2016
(86) PCT No.: PCT/JP2016/073205

§ 371 Date: Feb. 4, 2019

(51) Int. Cl. G01S 13/04; G01S 7/35

(52) U.S. Cl. CPC G01S 13/04; G01S 7/354

(57) ABSTRACT

An object detection apparatus 1000 is an apparatus for detecting an object 1001 using an electric wave. The object detection apparatus 1000 is provided with: a transmission unit 1091 that emits, as a transmission signal, an electric wave having a frequency which continuously changes over time; a reception unit 1092 that receives an electric wave from the object 1001 as a reception signal, and generates a baseband signal by mixing the transmission signal acquired from the transmission unit 1091 with the received signal; and a data processing unit 1093 that estimates the incoming direction of the electric wave on the basis of the measurement value of a baseband signal for each of sampling times, identifies an intensity distribution of the electric wave on the basis of the estimated incoming direction for each sampling time, and detects the object 1001 on the basis of the identified intensity distribution.

### TECHNICAL FIELD

The present invention relates to an object detection apparatus and an object detection method for detecting a target object on the basis of an electric wave reflected by the target object or emitted from the target object.

### BACKGROUND ART

Unlike light, electric waves (microwaves, millimeter waves, terahertz waves, and the like) have superior ability to penetrate objects. Imaging apparatuses (object detection apparatuses) that use such penetration of electric waves to create images of items concealed under clothing, objects in a person's bag, and so on for inspection are commonly used today. Likewise, remote sensing techniques that create images of the earth's surface, through clouds, from satellites or aircraft are also in common use.

Several methods have been proposed as methods for creating images using an object detection apparatus. One such method is the array antenna method (see Non-Patent Document 1, for example). The array antenna method will be described here using FIGS. 22 and 24. FIG. 22 is a diagram illustrating an object detection apparatus employing a conventional array antenna method. FIG. 23 is a diagram illustrating the configuration of a receiver illustrated in FIG. 22.

As illustrated in FIG. 22, in the array antenna method, the object detection apparatus includes a transmitter 211 and a receiver 201. The transmitter 211 includes a transmission antenna 212. The receiver 201 includes reception antennas 201₁, 202₂, . . . , 202_{N} (where N is the number of reception antennas).

The transmitter 211 emits an RF signal (electric wave) 213 from the transmission antenna 212 toward detection target objects 204₁, 204₂, . . . , 204_{K} (where K is the number of target objects). The RF signal (electric wave) 213 is reflected by the detection target objects 204₁, 204₂, . . . , 204_{K}, producing reflected waves 203₁, 203₂, . . . , 203_{K}, respectively.

The reflected waves 203₁, 203₂, . . . , 203_{L} that have been produced are received by the reception antennas 201₁, 202₂, . . . , 202_{N}. On the basis of the received reflected waves 203₁, 203₂, . . . , 203_{K}, the receiver 201 calculates electric wave intensities of the electric waves reflected by the detection target objects 204₁, 204₂, . . . , 204_{K}. The receiver 201 then creates an image of a distribution of the calculated electric wave intensities. Images of the detection target objects 204₁, 204₂, . . . , 204_{K}, respectively, are obtained in this manner.

When the array antenna method is employed, the receiver 201 includes N reception antennas 202₁, 202₂, . . . , 202_{N}, as illustrated in FIG. 23. The reception antennas 202₁, 202₂, . . . , 202_{N} receive K incoming waves 208₁, 208₂, . . . , 208_{K} having angles θₖ (where k=1, 2, . . . , K). The complex amplitudes of the incoming waves 208₁, 208₂, . . . , 208_{K} are assumed to be [s(θ₁), s(θ₂), . . . , s(θ_{K})]. The receiver 201 includes a downconverter (not shown in FIG. 23), and the downconverter extracts the complex amplitudes (baseband signal) [r₁, r₂, . . . , r_{N}] of the RF signals received by the reception antennas 202₁, 202₂, . . . , 202_{N}, respectively. The complex amplitudes [r₁, r₂, . . . , r_{N}] of the signals received by the reception antennas 202₁, 202₂, . . . , 202_{N} are output to a signal processing unit 205.

The relationship between the complex amplitudes [r₁, r₂, . . . , r_{N}] of the reception signals at the reception antennas 202₁, 202₂, . . . , 202_{N}, and the complex amplitudes [s(θ₁), s(θ₂), . . . , s(θ_{K})] of the incoming waves are given by the following Expression (1).

$$\begin{matrix}[ Expression 1 ] & \\ \begin{matrix}r = As + n ( t ) , & \\ r ≡ {[ {r}_{1} , {r}_{2} , … , {r}_{N} ]}^{T} , & ( N \times one \text{-} dimensional vector ) \\ s ≡ {[ s ( {θ}_{1} ) , s ( {θ}_{2} ) , … , s ( {θ}_{K} ) ]}^{T} , & ( K \times one \text{-} dimensional vector ) \\ A ≡ ( a ( {θ}_{1} ) , a ( {θ}_{2} ) , … , a ( {θ}_{K} ) ) , & ( N \times K dimensional matrix ) \\ a ( θ ) ≡ {[ exp ( j {ϕ}_{1} ( θ ) ) , exp ( j {ϕ}_{2} ( θ ) ) , … , exp ( j {ϕ}_{N} ( θ ) ) ]}^{T} , & ( N \times one \text{-} dimensional vector ) \\ {ϕ}_{n} ( θ ) ≡ - 2 π \cdot n \cdot d \cdot sin θ / λ , ( n = 1 , 2 , … , N ) & \end{matrix} \} & ( 1 )\end{matrix}$$

In Expression (1), n(t) represents a vector that takes a noise component as an element. The superscript T represents the transpose of a vector or a matrix. d represents an inter-antenna distance, and λ represents the wavelengths of the incoming waves (RF signals) 208₁, 208₂, . . . , 208_{K}.

In Expression (1), the complex amplitude r of a reception signal is an amount obtained through measurement. A direction matrix A is an amount that can be defined (specified) through signal processing. The complex amplitude s of the incoming wave is unknown, and thus determining the direction of the incoming wave s from the measured reception signal r is the goal of estimating the direction of the incoming wave.

An algorithm for estimating the incoming direction calculates a correlation matrix R=E[r·r^{H}] from the measured reception signal r. Here, E[ ] represents subjecting the elements within the brackets to time-averaged processing, and the superscript H represents a complex conjugate transpose. Next, any one of the evaluation functions indicated by the following Expressions (2) to (4) is calculated from the calculated correlation matrix R.

$$\begin{matrix}[ Expression 2 ] & \\ {P}_{BF} ( θ ) = \frac{{a}^{H} ( θ ) Ra ( θ )}{{a}^{H} ( θ ) a ( θ )} , \\ ( evaluation function using beam former method ) & ( 2 ) \\ [ Expression 3 ] & \\ {P}_{CP} ( θ ) = \frac{1}{{a}^{H} ( θ ) {R}^{- 1} a ( θ )} , \\ ( evaluation function using Capon method ) & ( 3 ) \\ [ Expression 4 ] & \\ {P}_{MU} ( θ ) = \frac{{a}^{H} ( θ ) a ( θ )}{{a}^{H} ( θ ) {E}_{N} {E}_{N}^{H} a ( θ )} , {E}_{N} = [ {e}_{K + 1} , … , {e}_{N} ] , \\ ( evaluation function using MUSIC method ) & ( 4 )\end{matrix}$$

E_{N}=[e_{K+1}, . . . , e_{N}] according to the MUSIC method is a matrix constituted by N−(K+1) vectors, in which of the eigenvectors in the correlation matrix R, the eigenvalues indicate the power of noise n(t).

In the conventional antenna array illustrated in FIG. 23, the process of calculating the correlation matrix R from the reception signal r, and furthermore the process of calculating the evaluation functions indicated by Expressions (2) to (4), are carried out by the signal processing unit 205.

According to the theory described in Non-Patent Document 1, the evaluation functions indicated by Expressions (2) to (4) have peaks at incoming wave angles θ₁, θ₂, . . . , θ_{K}. The angle of the incoming wave can thus be obtained by calculating the evaluation function and checking at its peak. The position and shape of an object can be displayed as an image from the angular distribution of the incoming waves obtained by the evaluation functions of Expressions (2) to (4).

Of the evaluation functions indicated by Expressions (A2) to (A4), the signal processing unit in the particular case of applying the beam former method of Expression (2) is illustrated in FIG. 24. FIG. 24 is a diagram illustrating an example in which the beam former method is applied in the receiver illustrated in FIG. 22.

Phase shifters 206₁, 206₂, . . . , 206_{N} and a synthesizer 207 of the conventional antenna array illustrated in FIG. 24 correspond to the signal processing unit 205 in the conventional antenna array illustrated in FIG. 23. The phase shifters 206₁, 206₂, . . . , 206_{N} add phase rotations Φ₁, Φ₂, . . . , Φ_{N} to the complex amplitudes 208₁, 208₂, . . . , 208_{N} of the incoming waves received by the reception antennas 202₁, 202₂, . . . , 202_{N}, respectively. The incoming waves 208₁, 208₂, . . . , 208_{N} to which the incoming wave phase rotations Φ₁, Φ₂, . . . , Φ_{N} have been added are added by the adder 207.

The phase shifters 206₁, 206₂, . . . , 206_{N} and the adder 207 may be implemented by an analog circuit, or may be implemented by software incorporated into a computer. In the array antenna method, the directivity of the array antenna is controlled by setting the phase rotations Φ₁, Φ₂, . . . , Φ_{N} in the phase shifters 206₁, 206₂, . . . , 206_{N}. Assuming that the directivity of the reception antenna 202 is represented by g(θ) and the amplitudes and phases of the incoming wave 208ₙ (where n=1, 2, . . . , N) received by the reception antenna 202ₙ are aₙ and φₙ, respectively, a directivity E(θ) of the array antenna is calculated as indicated by the following Expression (5).

$$\begin{matrix}[ Expression 5 ] & \\ E ( θ ) = g ( θ ) {\sum }_{n = 1}^{N} {a}_{n} exp ( j {φ}_{n} ) exp ( j {Φ}_{n} ) = g ( θ ) AF ( θ ) , & ( 5 )\end{matrix}$$

In Equation (5), a directivity component AF(θ) obtained by removing the directivity g(θ) of the reception antenna 202 from the directivity E(θ) of the array antenna is called the “array factor”. The array factor AF(θ) represents the effect of directivity caused by the formation of the array antenna. The signal received by the reception antenna 202ₙ (where n=1, 2, . . . , N) is g(θ)aₙ exp(jφₙ). Additionally, a signal obtained by adding the signals g(θ)aₙ exp(jφₙ)exp(jΦₙ) subjected to the phase rotation Φₙ of the phase shifter 206ₙ over n=1, 2, . . . , N in the adder 207 is obtained as the directivity E(θ) in Expression (5).

When the incident angle of the incoming waves 208₁, 208₂, . . . , 208_{N} is θ, the phase φₙ of the incoming wave 208ₙ is given by −2π·n·d·sin θ/λ (where n=1, 2, . . . , N). Here, d is the gap between the reception antennas 202ₙ (where n=1, 2, . . . , N), and λ is the wavelength of the incoming waves 208₁, 208₂, . . . , 208_{N}.

In the above Expression (5), when the amplitude aₙ is constant irrespective of n, setting the phase rotation Φₙ (where n=1, 2, . . . , N) of the phase shifter 206ₙ to be equal to a value obtained by multiplying the phase φₙ of the incoming wave 208ₙ by −1 results in the array factor AF(θ) being maximum in the direction of the angle θ. In other words, this indicates the method of controlling the directivity of the array antenna by the phase rotation Φₙ of the phase shifter 206ₙ.

Patent Documents 1 to 3 disclose other examples of object detection apparatuses using the array antenna method. Specifically, the object detection apparatuses disclosed in Patent Documents 1 and 2 use a phase shifter, which is connected to each of N reception antennas built into a receiver, to control the directivity of a reception array antenna formed from N reception antennas.

The object detection apparatuses disclosed in Patent Documents 1 and 2 change the directivities of the N reception array antennas formed in a beam shape, and receive direction beams of the reception array antennas for each of K objects to be detected. The intensities of the electric waves reflected by the objects to be detected are calculated in this manner.

The object detection apparatus disclosed in Patent Document 3 controls the directivity of N reception array antennas by using the frequency dependence of the N reception array antennas. Like the examples of Patent Documents 1 and 2, the object detection apparatus disclosed in Patent Document 3 also calculates the intensities of the electric waves reflected by the objects to be detected by directing the direction beams of the N reception array antennas for each of K objects to be detected.

An actual object detection apparatus displays a two-dimensional image, and thus N reception antennas 202 are arranged in the vertical direction and the horizontal direction, respectively, as illustrated in FIG. 25. In this case, the overall number of antennas required is N². FIG. 25 is a diagram illustrating the overall configuration of a reception array antenna when employing the conventional array antenna method.

The Mills Cross method is also known as a method for displaying a two-dimensional image (see Non-Patent Document 2, for example). FIG. 26 is a diagram illustrating an object detection apparatus employing the Mills Cross method. As illustrated in FIG. 26, this object detection apparatus includes one-dimensional array antennas 201 arranged in the vertical direction and one-dimensional array antennas 201 arranged in the horizontal direction. In this object detection apparatus, a multiplier 221 calculates the product of signals for each combination of reception antenna in the vertical direction and reception antenna in the horizontal direction. A two-dimensional image can therefore be displayed by using the calculated product.

Next, using FIG. 27, a synthetic aperture radar (SAR) method will be described as another method for creating an image in an object detection apparatus. FIG. 27 is a diagram illustrating an object detection apparatus employing a conventional synthetic aperture radar method.

As illustrated in FIG. 27, with the synthetic aperture radar method, the object detection apparatus includes a transmitter 311 and a receiver 301. The transmitter 311 includes a transmission antenna 312. The receiver 301 includes reception antennas 302₁ to 302_{N} (where N is the number of reception antennas).

The transmitter 311 emits an RF signal (electric wave) 313 from the transmission antenna 312 toward detection target objects 304₁, 304₂, . . . , 304_{K} (where K is the number of detection target objects). The RF signal (electric wave) 313 is reflected by the detection target objects 304₁, 304₂, . . . , 304_{K}, producing reflected waves 303₁, 303₂, . . . , 303_{L}, respectively.

At this time, while moving to the positions 301₂, . . . , 301_{N} from an initial position, a receiver 301₁ receives the reflected waves 303₁, 303₂, . . . , 303_{K} at each position. In FIG. 25, the reference numerals 302₁, 302₂, . . . , 302_{N} indicate the reception antennas at the respective positions.

Accordingly, the one reception antenna functions as the reception antennas 302₁, 302₂, . . . , 302_{N}. That is, in FIG. 27, one receiving antenna is equivalent to the reception antennas 202₁, 202₂, . . . , 202_{N} according to the array antenna method illustrated in FIG. 22, and forms a reception array antenna (a virtual array antenna) constituted by N antennas.

Accordingly, in the synthetic aperture radar method illustrated in FIG. 27 too, the receiver 301 calculates the intensities of the electric waves reflected by the detection target objects 304₁, 304₂, . . . , 304_{K} on the basis of the received reflected waves 303₁, 303₂, . . . , 303_{K}, in the same manner as with the array antenna method illustrated in FIG. 22. The receiver 301 then creates an image of a distribution of the calculated electric wave intensities. Images of the detection target objects 304₁, 304₂, . . . , 304_{K}, respectively, are obtained in this manner.

Note that Patent Documents 4 to 6 disclose examples of object detection apparatuses using the synthetic aperture radar method.

### LIST OF PRIOR ART DOCUMENTS

### Patent Document

Patent Document 1: JP 2013-528788A

Patent Document 2: JP 2015-014611A

Patent Document 3: Japanese Patent No. 5080795

Patent Document 4: Japanese Patent No. 4653910

Patent Document 5: JP 2011-513721A

Patent Document 6: JP 2015-036682A

### Non Patent Document

Non-Patent Document 1: Kikuma, N., “Fundamentals of Array Antennas”, MWE 2010 Digest (2010)

Non-Patent Document 2: B. R. Slattery, “Use of Mills cross receiving arrays in radar systems,” PROC. IEE, Vol. 113, No. 11, November 1966, pp. 1712-1722.

### DISCLOSURE OF THE INVENTION

### Problems to be Solved by the Invention

With the array antenna method, attempting to accurately detect an object requires an extremely high number of reception antennas and accompanying receivers, and as a result, there is a problem in that the object detection apparatus will have an increased cost, size, and weight.

This problem will be described in detail. First, with the array antenna method, it is necessary to provide a gap between the reception antennas 201₁, 202₂, . . . , 202_{N} less than or equal to half the wavelength λ of the reflected waves 203₁, 203₂, . . . , 203_{K} received by the receiver 201. For example, if the reflected waves 203₁, 203₂, . . . , 203_{K} are millimeter waves, the wavelength λ is approximately several mm, and thus the gap between the antennas is less than or equal to several mm. If these conditions are not met, a problem in which virtual images are produced in positions of the generated image where objects 204₁, 204₂, . . . , 204_{K} are not present will arise.

The resolution of the image is determined by a direction beam width Δθ of the reception array antennas (201₁, 202₂, . . . , 202_{N}). The direction beam width Δθ of the reception array antennas (201₁, 202₂, . . . , 202_{N}) is given by Δθ˜λ/D. Here, D represents the aperture size of the reception array antennas (201₁, 202₂, . . . , 202_{N}), and corresponds to the distance between the reception antennas 202₁ and 202_{N} located on either side. In other words, to achieve a resolution practically applicable for creating images of items concealed under clothing, items in a bag, or the like, it is necessary to set the aperture size D of the reception array antenna (201₁, 202₂, . . . , 202_{N}) to approximately several tens of centimeters to several meters.

Based on the above two conditions, that is, that the gaps between the N reception antennas be less than or equal to half the wavelength λ (less than or equal to several millimeters) and that it is necessary to provide a distance of at least approximately several tens of centimeters between the reception antennas on either end, the number N of antennas necessary in a single column is approximately several hundred.

Additionally, an actual object detection apparatus displays a two-dimensional image, and thus N reception antennas 202 are arranged in the vertical direction and the horizontal direction, respectively, as illustrated in FIG. 26. In this case, the overall number of reception antennas required is N². Thus, in order to employ the array antenna method, the overall number of reception antennas and the number of receivers accompanying the antennas is approximately several tens of thousands.

With such a large number of reception antennas and receivers being necessary, the cost will be extremely high if the array antenna method is used, as described above. Furthermore, because the antennas are arranged in a quadrangular region that is several tens of cm to several m on a side, the apparatus will have an extremely large size and heavy weight.

According to the above-described object detection apparatus employing the Mills Cross method illustrated in FIG. 26, a smaller number of reception antennas and receivers can be used than when using the array antenna method. However, even in this case, the required number of reception antennas and receivers is 2N, and thus approximately several hundred reception antennas will still be necessary. It is therefore difficult to solve the problems of cost, apparatus size, and weight in this case as well.

Furthermore, with the above-described object detection apparatus employing the synthetic aperture radar method illustrated in FIG. 27, it is necessary to mechanically move the receiver, which is problematic in that it is difficult to shorten the scanning time. This problem leads to another problem in that when scanning items or people with the object detection apparatus, only a limited number of items can be scanned in each unit of time. The object detection apparatus disclosed in Patent Document 6 requires a mechanical mechanism for moving the receiver, which is problematic in that the apparatus will have a larger size and heavier weight.

Thus as discussed above, a typical object detection apparatus has an extremely high cost, large size, and heavy weight. The applications and opportunities for actually using such an object detection apparatus are therefore limited. The speed at which objects can be scanned may also be limited depending on the method that is employed.

One object of the present invention is to solve the above-described problems by providing an object detection apparatus and object detection method that can suppress an increase in the apparatus cost, size, and weight while improving accuracy when detecting an object using electric waves.

### Means for Solving the Problems

To achieve the above-described object, an object detection apparatus according to one aspect of the present invention is an object detection apparatus for detecting an object using an electric wave, the apparatus including: a transmission unit that emits, as a transmission signal, an electric wave having a frequency that continuously changes over time; a reception unit that acquires the transmission signal, receives the electric wave from the object as a reception signal, and furthermore generates a baseband signal by mixing the acquired transmission signal with the received reception signal; and a data processing unit that estimates an incoming direction of the electric wave on the basis of a measurement value of the baseband signal for each of sampling times, identifies an intensity distribution of the electric wave on the basis of the estimated incoming direction of the electric wave, and detects the object on the basis of the identified intensity distribution.

Additionally, to achieve the above-described object, an object detection method according to one aspect of the present invention is a method of detecting an object using an electric wave, the method including: (a) a step of a transmitter emitting, as a transmission signal, an electric wave having a frequency that continuously changes over time; (b) a step of a receiver acquiring the transmission signal, receiving the electric wave from the object as a reception signal, and furthermore generating a baseband signal by adding the acquired transmission signal to the received reception signal; and (c) a step of a data processing apparatus estimating an incoming direction of the electric wave on the basis of a measurement value of the baseband signal for each of sampling times, identifying an intensity distribution of the electric wave on the basis of the estimated incoming direction of the electric wave, and detecting the object on the basis of the identified intensity distribution.

### Advantageous Effects of the Invention

According to the present invention as described above, an increase in the apparatus cost, size, and weight can be suppressed while improving the accuracy when detecting an object using an electric wave.

### BRIEF DESCRIPTION OF THE DRAWINGS

FIG. 1 is a block diagram illustrating the overall configuration of an object detection apparatus according to a first embodiment of the present invention.

FIG. 2 is a schematic diagram illustrating the principles of operation of the object detection apparatus according to the first embodiment of the present invention.

FIG. 3 is a diagram illustrating changes in the frequency of a transmitted electric wave according to the first embodiment of the present invention.

FIG. 4 is a diagram illustrating a correspondence relationship between parameters used in a conventional array antenna method and parameters used in a time-virtual array method according to an embodiment of the present invention.

FIG. 5 is a diagram illustrating the principles of operation of the object detection apparatus according to the first embodiment of the present invention.

FIG. 6 is a diagram illustrating principles of operation when a beam former method is applied in the object detection apparatus illustrated in FIG. 5.

FIG. 7 is a properties graph illustrating an example of the directivity of antenna gain in the object detection apparatus according to the first embodiment of the present invention.

FIG. 8 is a diagram illustrating the occurrence of virtual images in a virtual array according to the first embodiment of the present invention.

FIG. 9 is a block diagram illustrating an example of the specific configuration of the object detection apparatus according to the first embodiment of the present invention.

FIG. 10 is a flowchart illustrating operations of the object detection apparatus according to the first embodiment of the present invention.

FIG. 11 is a diagram illustrating the configuration and principles of operation of an object detection apparatus according to a second embodiment of the present invention.

FIG. 12 is a diagram illustrating the concept of a sub array used in the object detection apparatus according to the second embodiment of the present invention.

FIG. 13 is a flowchart illustrating operations of the object detection apparatus according to the second embodiment of the present invention.

FIG. 14 is a diagram illustrating the configuration and principles of operation of an object detection apparatus according to a third embodiment of the present invention.

FIG. 15 is a diagram illustrating a method of calculating a correlation matrix of a two-dimensional frequency-virtual array according to the third embodiment of the present invention.

FIG. 16 is a diagram illustrating a method of calculating a correlation matrix of a two-dimensional frequency-virtual array according to the third embodiment of the present invention.

FIG. 17 is a flowchart illustrating operations of the object detection apparatus according to the third embodiment of the present invention.

FIG. 18 is a diagram illustrating an example of an image output from the object detection apparatus according to the third embodiment of the present invention.

FIG. 19 is a diagram illustrating the overall configuration of an object detection apparatus according to a fourth embodiment of the present invention.

FIG. 20 is a block diagram illustrating in detail the configuration of the object detection apparatus according to the fourth embodiment of the present invention.

FIG. 21 is a diagram illustrating an example of frequency control carried out according to the fourth embodiment of the present invention.

FIG. 22 is a diagram illustrating an object detection apparatus employing a conventional array antenna method.

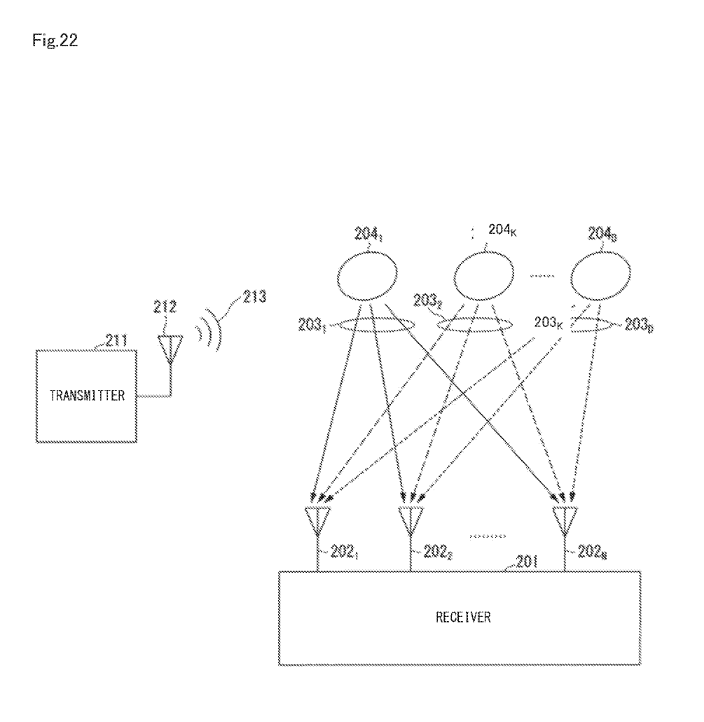

FIG. 23 is a diagram illustrating the configuration of a receiver illustrated in FIG. 22.

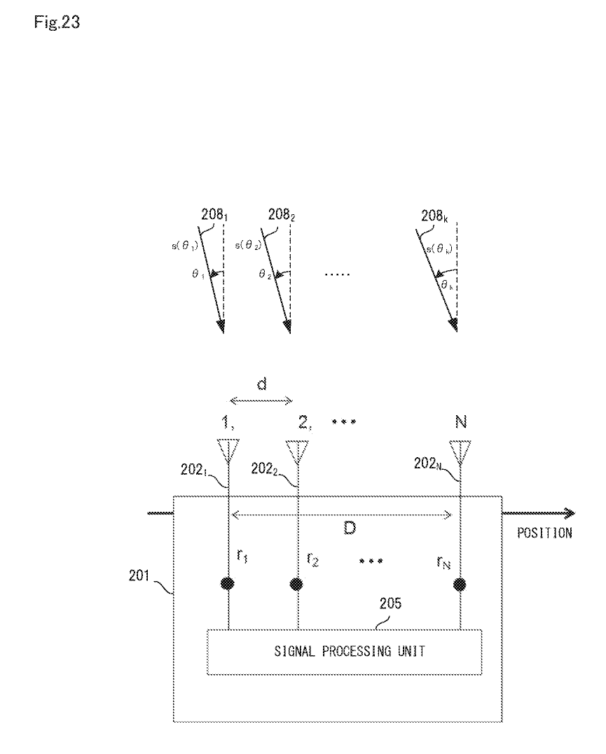

FIG. 24 is a diagram illustrating an example in which the beam former method is applied in the receiver illustrated FIG. 22.

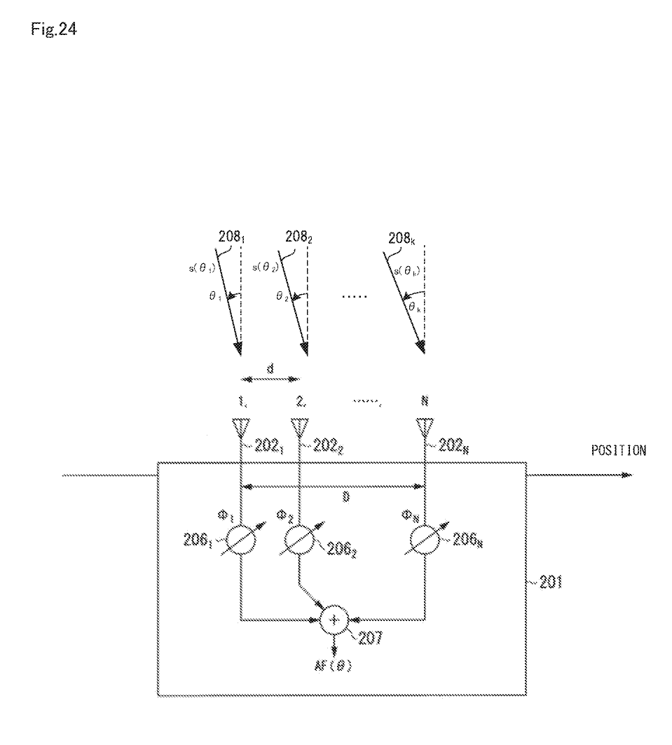

FIG. 25 is a diagram illustrating the overall configuration of a reception array antenna when employing the conventional array antenna method.

FIG. 26 is a diagram illustrating an object detection apparatus employing the Mills Cross method.

FIG. 27 is a diagram illustrating an object detection apparatus employing a conventional synthetic aperture radar method.

### MODE FOR CARRYING OUT THE INVENTION

### First Embodiment

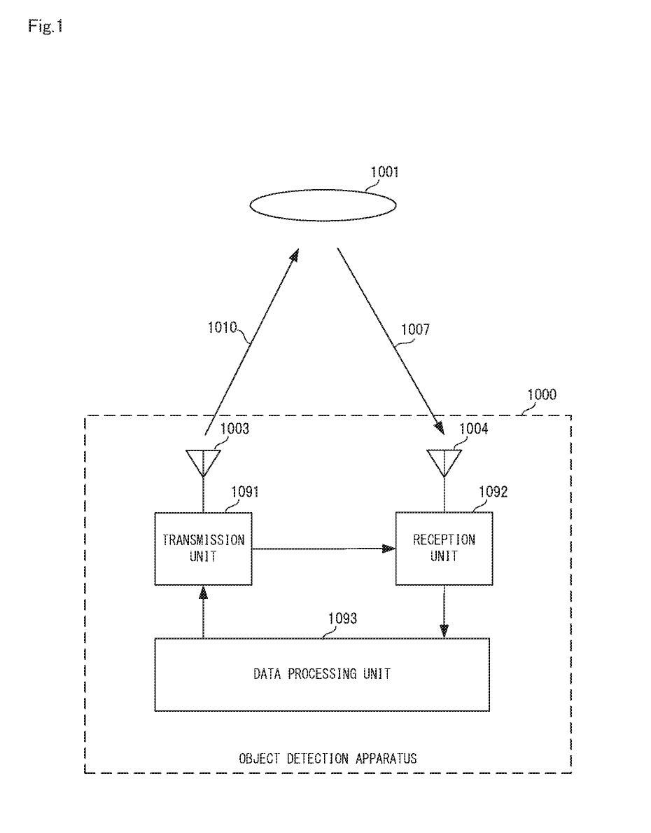

An object detection apparatus and an object detection method according to a first embodiment of the present invention will be described hereinafter, with reference to FIGS. 1 to 10.

Apparatus Configuration

First, the overall configuration of the object detection apparatus according to the present first embodiment will be described using FIG. 1. FIG. 1 is a block diagram illustrating the overall configuration of the object detection apparatus according to the first embodiment of the present invention.

An object detection apparatus 1000 according to the present first embodiment, illustrated in FIG. 1, is an apparatus for detecting an object 1001 using an electric wave. As illustrated in FIG. 1, the object detection apparatus 1000 includes a transmission unit 1091, a reception unit 1092, and a data processing unit 1093.

The transmission unit 1091 emits, as a transmission signal, an electric wave having a frequency which continuously changes over time. The reception unit 1092 acquires the transmission signal and receives, as a reception signal, and electric wave from the object (called a “target object” hereinafter) 1001 that is to be detected. Furthermore, the reception unit 1092 generates a baseband signal by multiplying (mixing) the acquired transmission signal with the received reception signal.

As illustrated in FIG. 1, in the present first embodiment, the transmission unit 1091 includes a transmission antenna 1003, and the reception unit 1092 includes a reception antenna 1004. Although the example of FIG. 1 illustrates only a single reception unit 1092, there may be a plurality of reception units 1092 and reception antennas 1004 in the present first embodiment. However, the number of reception units 1092 and reception antennas 1004 in the present first embodiment is extremely low compared to conventional techniques.

The data processing unit 1093 estimates the incoming direction of the electric wave from a measurement value of the baseband signal in each of sampling times. Then, on the basis of the estimated incoming direction of the electric wave, the data processing unit 1093 identifies an intensity distribution of the electric wave, and on the basis of the identified intensity distribution, detects the target object 1001.

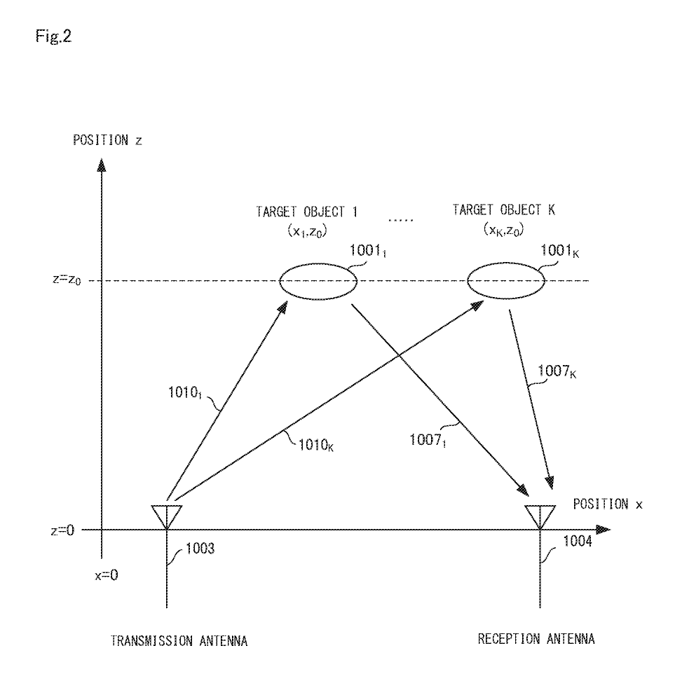

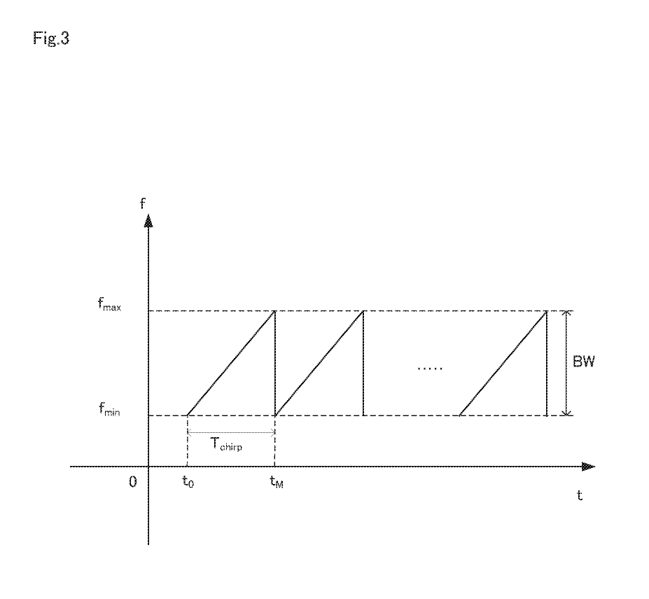

The principles of operation of the object detection apparatus 1000 will be described first using FIGS. 2 and 3. FIG. 2 is a diagram illustrating the principles of operation of the object detection apparatus according to the first embodiment of the present invention. FIG. 3 is a diagram illustrating changes in the frequency of a transmitted electric wave according to the first embodiment of the present invention.

In the example illustrated in FIG. 2, the transmission antenna 1003 and the reception antenna 1004 are arranged on the x axis, and K target objects 1001₁, . . . , 1001_{K} are arranged in positions (x₁,z₀), . . . , (x_{K},z₀), respectively. It is assumed that an RF signal 1010 having a carrier frequency f that changes linearly is transmitted from the transmission antenna 1003, as illustrated in FIG. 3. The carrier frequency f changes from a minimum frequency fₘᵢₙ to a maximum frequency fₘₐₓ over a single chirp period (T_{chirp}). A bandwidth of the carrier frequency f (=fₘₐₓ−fₘᵢₙ) is defined as “BW”, and a time gradient of the carrier frequency is defined as α=BW/T_{chirp}.

In the example illustrated in FIG. 2, RF signals 1010₁, . . . , 1010_{K} are emitted from the transmission antenna 1003 toward the target objects 1001₁, . . . , 1001_{K}, respectively. Furthermore, reflected waves 1007₁, . . . , 1007_{K} from the target objects 1001₁, . . . , 1001_{K} are received by the reception antenna 1004.

A compound wave of the reflected waves 1007₁, . . . , 1007_{K} received by the reception antenna 1004 is multiplied (mixed) with the transmission signal acquired from the transmission unit 1091 in the reception unit 1092 illustrated in FIG. 1. The baseband signal is generated as a result. A baseband signal I(t) is given by the following Expression 6.

$$\begin{matrix}[ Expression 6 ] & \\ I ( t ) = {\sum }_{k = 1}^{K} σ ( {x}_{k} ) cos [ 2 π ( {f}_{min} + α {t}^{′} ) L ( {x}_{k} ) / c ] , \\ {t}^{′} = t - {hT}_{chirp} , & ( 6 )\end{matrix}$$

In Expression (6), t′ represents a time within one chirp period, and corresponds to t₀ to t_{M} in FIG. 3. h represents a chirp number, and as indicated by t′=t−h·T_{chirp}, it is necessary to take t′ from t₀ each time one chirp period (T_{chirp}) passes. σ(xₖ) represents the reflectance of a target object k (where k=1, 2, . . . , K). L(xₖ) represents a propagation distance from the transmission antenna to the reception antenna via the target object k. c represents the speed of light.

The IF signal I(t) is an in-phase component (in-phase signal). A DC component (quadrature signal) Q(t) is generated by carrying out a Hilbert transformation on the in-phase component I(t). The in-phase component I(t) and the DC component Q(t) may be generated using a DC modulator. The DC component Q(t) is given by the following Expression (7).

$$\begin{matrix}[ Expression 7 ] & \\ Q ( t ) = {\sum }_{k = 1}^{K} σ ( {x}_{k} ) sin [ 2 π ( {f}_{min} + α {t}^{′} ) L ( {x}_{k} ) / c ] , & ( 7 )\end{matrix}$$

A complex baseband signal r(t), expressed by the following Expression (8), is generated from the in-phase component I(t) and the DC component Q(t).

$$\begin{matrix}[ Expression 8 ] & \\ \begin{matrix}r ( t ) = I ( t ) - jQ ( t ) = {\sum }_{k = 1}^{K} {σ}^{′} ( {x}_{k} ) exp [ - j 2 π \cdot α {t}^{′} \cdot L ( {x}_{k} ) / c ] , \\ {σ}^{′} ( {x}_{k} ) ≡ σ ( {x}_{k} ) exp [ - j 2 π {f}_{min} L ( {x}_{k} ) / c ] ,\end{matrix} \} & ( 8 )\end{matrix}$$

The complex baseband signal r(t) is a quantity that can be calculated from measurement data. The purpose here is to find the dependence of the reflectance σ on the position x, and particularly the position x at which σ(x)=0, from the complex signal r(t) obtained from measurement data. If the position x at which σ(x)=0 is known, the position, shape, and so on of the target object can be determined.

A quantity σ′(x) is defined in Expression (8). The relationship between σ(x)=0 and σ′(x)=0 is one of having the same values, and thus finding the position x at which σ′(x)=0 can also be called the purpose here.

The above Expression (8) can also be written as the following Expression (9).

$$\begin{matrix}[ Expression 9 ] & \\ \begin{matrix}r = A {σ}^{′} + n ( t ) , & & \\ r ≡ {[ r ( {t}_{1} ) , r ( {t}_{2} ) , … , r ( {t}_{N} ) ]}^{T} , & & ( N \times one \text{-} dimensional vector ) \\ {σ}^{′} ≡ {[ {σ}^{′} ( {x}_{1} ) , {σ}^{′} ( {x}_{2} ) , … , {σ}^{′} ( {x}_{K} ) ]}^{T} , & & ( K \times one \text{-} dimensional vector ) \\ A ≡ ( a ( {x}_{1} ) , a ( {x}_{2} ) , … , a ( {x}_{K} ) ) , & & ( N \times K dimensional matrix ) \\ a ( x ) ≡ {[ exp ( j {ϕ}_{1} ( x ) ) , exp ( j {ϕ}_{2} ( x ) ) , … , exp ( j {ϕ}_{N} ( x ) ) ]}^{T} , & & ( N \times one \text{-} dimensional vector )\end{matrix} & ( 9 ) \\ {ϕ}_{n} ( x ) = - 2 π \cdot n \cdot α Δ t \cdot L ( x ) / c , ( n = 1 , 2 , … , N ) & \end{matrix}$$

In Expression (9), t₁, t₂, . . . , t_{N} are sampling times within one chirp period. Here, N represents a sampling point number per single chirp period. Δt represents a sampling period, and is given as Δt=tₙ₊₁−tₙ. In expanding Expression (8) to Expression (9), a vector n(t) that takes a noise component (random number) as an element is added to the reception signal r.

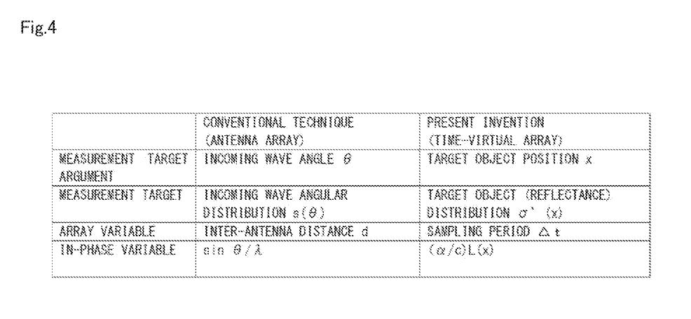

Comparing Expression (1), which indicates the operations of the conventional antenna array described in the background art, and Expression (9), which indicates the operations according to the present embodiment, it can be seen that adding the correspondence relationship (substitution) of the parameters indicated in FIG. 4 has both operations being the same type. Using this, a method that is the same type as the incoming direction estimation algorithm used in the conventional antenna array can be applied as-is in the present embodiment to estimate the incoming direction of the electric wave. FIG. 4 is a diagram illustrating the correspondence relationship between parameters used in the conventional array antenna method and parameters used in a time-virtual array method according to an embodiment of the present invention.

In other words, in the present embodiment, a correlation matrix R=E[r·r^{H}] is calculated from the reception signal (complex baseband signal) r obtained through measurement and defined in Expression (9), and then, one of the evaluation functions indicated in the following Expressions (10) to (12) is calculated from the calculated correlation matrix R.

$$\begin{matrix}[ Expression 10 ] & \\ {P}_{BF} ( x ) = \frac{{a}^{H} ( x ) Ra ( x )}{{a}^{H} ( x ) a ( x )} , \\ ( evaluation function using beam former method ) & ( 10 ) \\ [ Expression 11 ] & \\ {P}_{CP} ( x ) = \frac{1}{{a}^{H} ( x ) {R}^{- 1} a ( x )} , \\ ( evaluation function using Capon method ) & ( 11 ) \\ [ Expression 12 ] & \\ {P}_{MU} ( x ) = \frac{{a}^{H} ( x ) a ( x )}{{a}^{H} ( x ) {E}_{N} {E}_{N}^{H} a ( x )} , {E}_{N} = [ {e}_{K + 1} , … , {e}_{N} ] , \\ ( evaluation function using MUSIC method ) & ( 12 )\end{matrix}$$

In the above Expressions (10) to (12), a direction vector a(x) uses that defined in Expression (9). Additionally, E_{N}=[e_{K+1}, . . . , e_{N}] according to the MUSIC algorithm is a matrix constituted by N−(K+1) vectors, in which of the eigenvectors in the correlation matrix R, the eigenvalues indicate the power of noise n(t).

The evaluation functions indicated in Expressions (10) to (12) have peaks at positions x₁, x₂, . . . , x_{K} where the target object is present. The position of the target object (region of presence) can thus be obtained by calculating the evaluation function and checking at its peak. The position and shape of the target object can be displayed as an image from the position distribution of the target object obtained by the evaluation functions of Expressions (10) to (12). The foregoing descriptions correspond to the present embodiment.

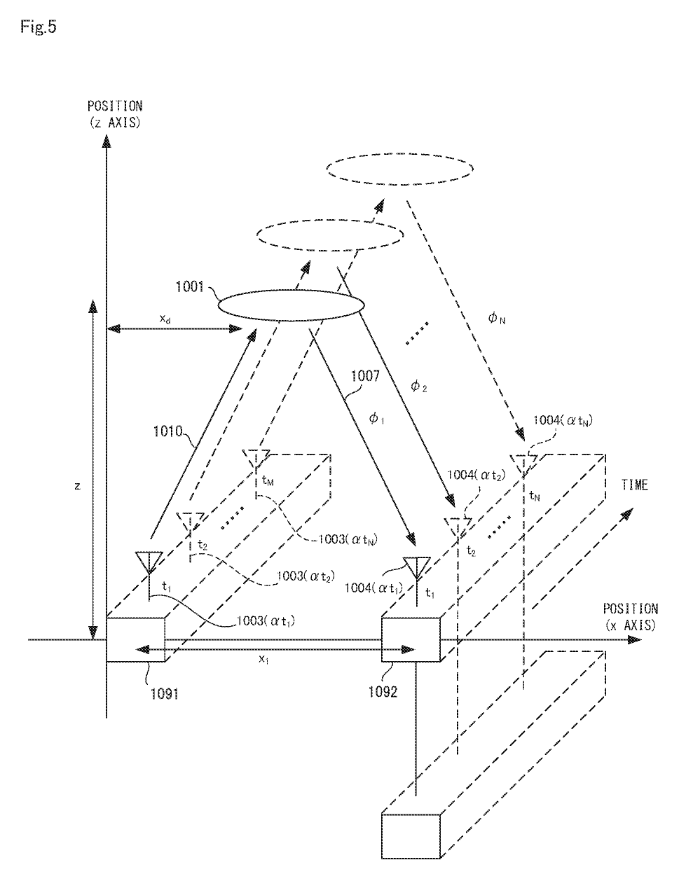

Descriptions that enable more intuitive understanding of the principles of the present embodiment will be provided next. Here, of the correspondence relationship of the parameters indicated in FIG. 4, the correspondence relationship between the antenna gap d in the conventional antenna array and the sampling time Δt in the present embodiment will be given particular attention. Focusing on this correspondence relationship, the incoming direction of the electric wave can be interpreted as estimated using data received by the N antennas arranged at the antenna gap d in the conventional antenna array, while the present embodiment can be interpreted as estimating the incoming direction of the electric wave with N pieces of reception data obtained in the respective sampling times Δt. In other words, the present embodiment can be interpreted as treating the data obtained in the respective sampling times as virtual antennas, constructing a virtual antenna array (time-virtual array) with the N virtual antennas arranged on the time axis, and estimating the incoming direction, as illustrated in FIG. 5.

FIG. 5 is a diagram illustrating the principles of operation of the object detection apparatus according to the first embodiment of the present invention. The example illustrated in FIG. 5, measurement is carried out using virtual transmission antennas 1003(t₁), 1003(t₂) . . . , 1003(t_{N}), and virtual reception antennas 1004(t₁), 1004(t₂), . . . , 1004(t_{N}), in each sampling time.

In FIG. 5, the receiver 1092 generates a reception signal (complex baseband signal) r by multiplying (mixing) the transmission signals 1003(t₁), 1003(t₂), . . . , 1003(t_{N}) acquired from the transmission unit 1091 with the reception signals 1004(t₁), 1004(t₂), . . . , 1004(t_{N}). The generated reception signal r is output to a signal processing unit 1095. Then, the process of calculating a correlation matrix R from the reception signal r, and furthermore the process of calculating the evaluation functions indicated by Expressions (10) to (12), are carried out by the signal processing unit 1095. The signal processing unit 1095 is included in the data processing unit 1093 illustrated in FIG. 1.

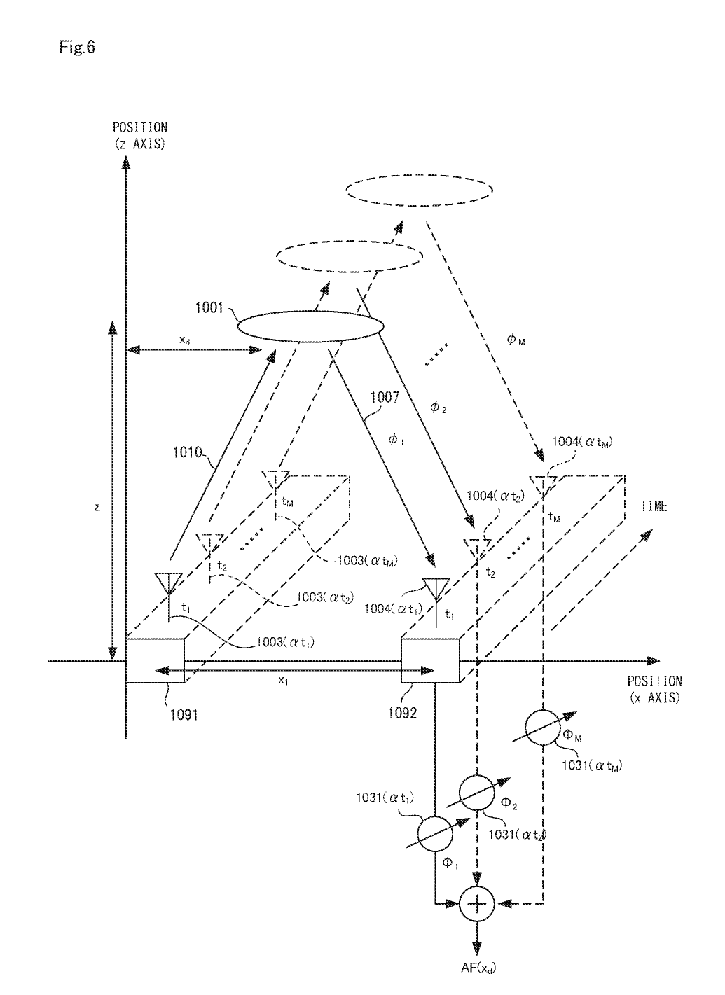

If, in the configuration of the object detection apparatus according to the present embodiment illustrated in FIG. 5, the signal processing unit 1095 is adapted specifically to the beam former method, the configuration becomes as illustrated in FIG. 6. FIG. 6 is a diagram illustrating principles of operation when the beam former method is applied in the object detection apparatus illustrated in FIG. 5. In FIG. 6, the signal processing unit 1095 is constituted by a phase shifter 1031 and an adder 1032. (In the following, the sampling point number will be switched from N to M.)

Reflected waves 1007 (or a complex amplitude thereof) received by virtual reception antennas 1004(t₁), 1004(t₂), . . . , 1004(t_{M}) subjected to phase rotations Φ₁, Φ₂ . . . , Φ_{M} in phase shifters 1031(t₁), 1031(t₂), . . . , 1031(t_{M}), and are then added by the adder 1032.

In the present first embodiment, the phase rotation by the phase shifters 1031(t₁), 1031(t₂), . . . , 1031(t_{M}) and the adding by the adder 1032 can be executed as processing by the data processing unit 1093, and specifically as processing through software using a processor.

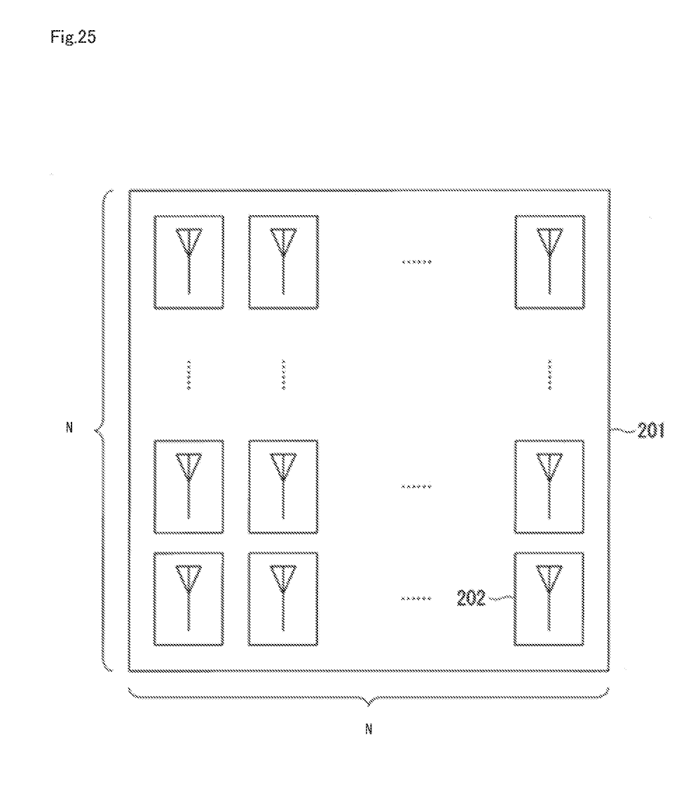

A principle of the object detection apparatus 1000 according to the present first embodiment is, as described earlier, constructing a virtual array antenna with data measured at each of sampling times t₁, t₂, . . . , t_{M}, and then estimating the direction of the incoming wave using that virtual array antenna. Thus, like the typical array antenna illustrated in FIG. 25, an array factor AF(x_{d}) can be calculated in the virtual array illustrated in FIG. 6 as well.

Here, it is assumed that positional coordinates using the x axis and z axis are set, with the position of the transmission unit 1091 being at (0,0), the position of the reception unit 1092 being at (xᵣ,0), and the position of the target object 1001 being at (x_{d},z). When the amplitude and phase of a reflected wave 1007(tₘ) received by a virtual reception antenna 21(tₘ) (where m=1, 2, . . . , M) are represented by aₘ and φₘ, respectively, the array factor AF(x_{d}) in the virtual array according to the present invention is calculated as indicated by the following Expression (13).

$$\begin{matrix}[ Expression 13 ] & \\ AF ( {x}_{d} ) = {\sum }_{m = 1}^{M} {a}_{m} exp ( j {φ}_{m} ) exp ( j {Φ}_{m} ) , & ( 13 )\end{matrix}$$

The phase φₘ (where m=1, 2, . . . , M) of a reflected wave 102(tₘ) is given by the following Expression (14).

[Expression 14]

φₘ=−2π·m·αΔt[Lₜ(x_{d})+Lᵣ(x_{d})]/c, (14)

In Expression (14), α·Δt represents a difference between the carrier frequency f (a frequency gap) in each sampling from sample to sample. Lₜ(x_{d}) represents the distance between the transmission unit 1091 and the target object 1001, and Lᵣ(x_{d}) represents the distance between the reception unit 20 and the target object 1001. c represents the speed of light. If, in Expression (3), the amplitude aₘ is constant regardless of m, the array factor AF(x_{d}) will be maximum in the direction of the target object 1001 (position x_{d}) if the phase rotation Φₘ (where m=1, 2, . . . , M) by the phase shifter 1031(tₘ) is set to be equal to the phase φₘ of the reflected wave 1007(tₘ). This indicates the method of controlling the directivity of the virtual array by the phase rotation Φₘ (where m=1, 2, . . . , M) of a phase shifter 22(tₘ) according to the present first embodiment.

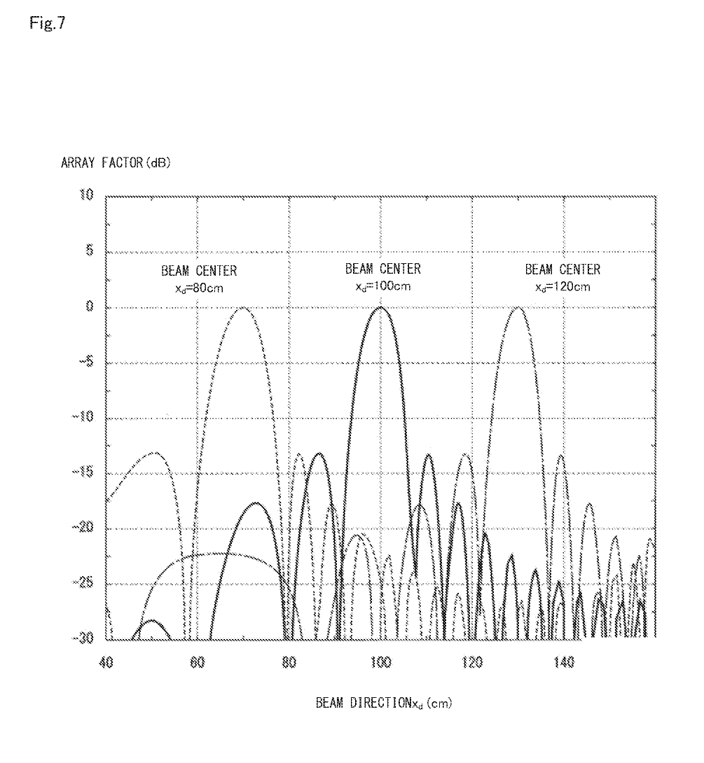

FIG. 7 is a properties graph illustrating an example of the directivity of antenna gain in the object detection apparatus according to the first embodiment of the present invention. Specifically, FIG. 7 indicates the results of calculating the array factor AF(x_{d}) of the virtual array using the above-described Expressions (2) and (3).

In the example of FIG. 7, the phase rotation Φₘ (where m=1, 2, . . . , M) of the phase shifter 22(tₘ) is set so that beam centers of the virtual array are at positions x_{d}=80 cm, 100 cm, and 120 cm with respect to the position (x_{d},z) of an object 200. The example in FIG. 7 indicates the array factor (i.e., the beam pattern) of the virtual array in this case.

In the calculation of the example illustrated in FIG. 7, a frequency interval αΔt is set to 250 MHz; the sampling number M, to 21; the z axis coordinate position z of the target object 1001, to 100 cm; and a distance xᵣ between the transmission unit 1091 and the reception unit 1092, to 100 cm.

Thus as can be seen from FIG. 7, in the virtual array according to the present first embodiment as well, the directivity (beam pattern) of the virtual array can be controlled by the phase rotation Φₘ (where m=1, 2, . . . , M) of the phase shifter 1031(tₘ). The beam width of the beam pattern can be calculated from the array factor AF(x_{d}) given by the above-described Expressions (2) and (3). The beam width is an element that determines the estimated incoming direction and the imaging (image) resolution. In the present first embodiment, a beam width Δx is given by the following Expression (15).

$$\begin{matrix}[ Expression 15 ] & \\ Δ x = \frac{c}{BW} h ( {x}_{r} , {x}_{d} , z ) , & ( 15 )\end{matrix}$$

In Expression (15), BW represents the above-described RF carrier frequency bandwidth. Using the frequency interval αΔt and the sampling number M, BW can be expressed as BW=αΔt×M. Additionally, in Expression (4), h(xᵣ,x_{d},z) is a function of a position variable (xᵣ,x_{d},z). Note that when xᵣ=x_{d}, h(xᵣ,x_{d},z) is given by [1+(z/xᵣ)2]1/2.

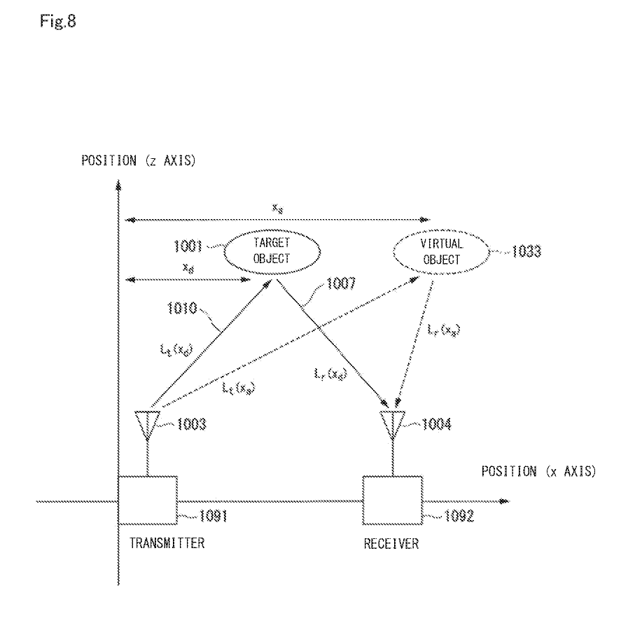

As indicated by Expression (15), with the virtual array according to the present first embodiment, a broader bandwidth BW produces a narrower beam width Δx and higher-resolution performance. However, as with a typical array antenna, virtual images caused by grating lobes may arise in the virtual array according to the present first embodiment as well. The occurrence of virtual images will be described next using FIG. 8. FIG. 8 is a diagram illustrating the occurrence of virtual images in the virtual array according to the first embodiment of the present invention.

A phase amount φ(xₐ) is defined by Expression (16).

[Expression 16]

φ(xₐ)=−2πα·Δt·[Lₜ(xₐ)+Lᵣ(xₐ)−Lₜ(x_{d})−Lᵣ(x_{d})]/c, (16)

The phase amount φ(xₐ) in Expression (16) corresponds to a difference between a phase shift in the electric wave from the transmission unit 1091 to the reception unit 1092 via a virtual image 1033 (position xₐ) and a phase shift of the electric wave from the transmission unit 1091 to the reception unit 1092 via the target object 1001 (position x_{d}), in FIG. 8. When the phase φ(xₐ) is an integral multiple of 2π at the position xₐ, the same array factor is obtained at the position xₐ and the position x_{d} of the target object. In other words, even if the target object is not actually present at the position xₐ, an image of the target object 1001 (i.e., the virtual image 1033) will arise at the position xₐ. As such, the region satisfying |φ(x)|<π, i.e., a range of the position x satisfying the following Conditional Expression (17), can be used as a region where no virtual image arises (a visible region).

$$[ Expression 17 ]$$

$$\vert {L}_{t} ( x ) + {L}_{r} ( x ) - {L}_{t} ( {x}_{d} ) - {L}_{r} ( {x}_{d} ) \vert < \frac{c}{2 ( α \cdot Δ t )} , \qquad ( 17 )$$

From Expression (17), it can be seen that the lower the frequency interval αΔt is, i.e., the shorter the sampling interval is made, the broader the visible region becomes. The size (length) of the visible region is generally inversely proportional to the frequency interval α·Δt.

In this manner, when estimating the incoming direction of a reflected wave using a virtual array and carrying out an imaging process (generating an image) from the result thereof, the number of pixels in a single direction is given by the ratio of the visible region to the resolution. From the results indicated in Expressions (15) to (17), a relationship of the number of pixels in a single direction=visible region/resolution ∝BW/αΔt=M, is obtained (where BW represents the bandwidth, αΔt represents the frequency interval, and M represents the sampling number). In other words, in the present first embodiment, the sampling number M may be set in accordance with the required number of pixels.

In the present first embodiment, the phase is controlled by the data processing unit 1093 for the measurement value in each sampling time of the baseband signal, output by the reception unit 1092. Through this phase control, the directivity of the effective antenna gain is controlled in the reception unit 1092, and an intensity distribution of the electric wave arriving at the reception unit 1092 is measured through the control of the directivity of the antenna gain, which makes it possible to detect the position and shape of the target object 1001. It is therefore not necessary to prepare a large number of reception antennas and receivers as in the conventional techniques. According to the present first embodiment, an increase in the apparatus cost, size, and weight can be suppressed while improving the accuracy when detecting an object using an electric wave.

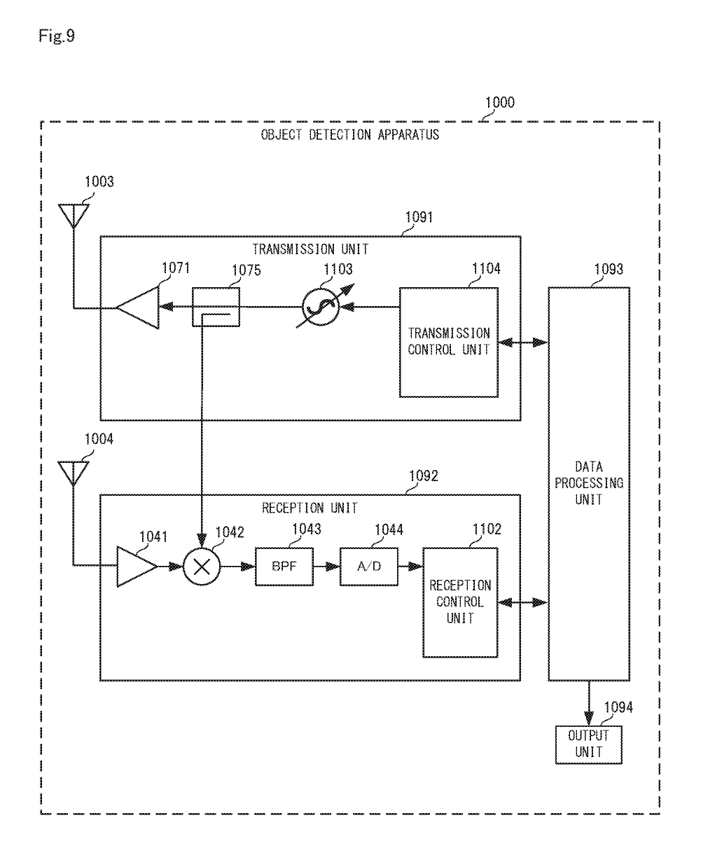

Next, the specific configuration of the object detection apparatus according to the present first embodiment will be described using FIG. 9. FIG. 9 is a block diagram illustrating an example of the specific configuration of the object detection apparatus according to the first embodiment of the present invention.

As illustrated in FIG. 9, in the present first embodiment, the object detection apparatus 1000 includes an output unit 1094 in addition to the transmission unit 1091, the reception unit 1092, and the data processing unit 1093. In actuality, according to the present first embodiment, the transmission unit 1091 is constituted by a transmitter and the reception unit 1092 is constituted by a receiver. Furthermore, the data processing unit 1093 is constituted by a data processing apparatus, i.e., by a calculator (a computer). This will be described in detail below.

As illustrated in FIG. 9, the transmission unit 1091 includes at least a power amplifier 1071, a coupler 1075, an oscillator 1103 having a variable frequency function, and a transmission control unit 1104, in addition to the transmission antenna 1003.

In the transmission unit 1091, the oscillator 1103 outputs a transmission RF signal. The transmission RF signal output from the oscillator 1103 is amplified by the power amplifier 1071 and then sent from the transmission antenna 1003 as the transmission RF signal 1010.

In the transmission unit 1091, the transmission control unit 1104 controls the frequency of the RF signal output by the oscillator 1103. In the present first embodiment, the frequency of the RF signal output by the oscillator 1103 (=the carrier frequency of the transmission RF signal 1010) is controlled to change continuously as time passes. Controlling the frequency of the RF signal as indicated in FIG. 3 is a particularly desirable embodiment.

The RF signal output by the oscillator 1103 is output to a mixer 1042 in the reception unit 1092 via the coupler 1075. As will be described later, the RF signal output to the mixer 1042 via the coupler 1075 is used as a LO signal of the reception unit 1092.

Additionally, as illustrated in FIG. 9, the reception unit 1092 includes a low-noise amplifier 1041, the mixer 1042, a filter 1043, an analog-digital converter 1044, and a reception control unit 1102, in addition to the reception antenna 1004.

As described above using FIGS. 1 to 6, the reception unit 1092 receives, through the provided reception antenna 1004, the electric wave (RF signal) 1007 reflected by the target object 1001. The RF signal 1007 received through the reception antenna 1004 is amplified by the low-noise amplifier 1041 and is then input to the mixer 1042.

The mixer 1042 mixes the reception RF signal amplified by the low-noise amplifier 1041 with the RF signal output from the transmission unit 1091 via the coupler 1075 (the reception LO signal) to generate an intermediate frequency signal (IF signal) serving as the baseband signal, and outputs the generated signal to the filter 1043. The filter 1043 removes noise from the baseband signal and inputs the noise-removed baseband signal to the analog-digital converter 1044.

The analog-digital converter 1044 converts the baseband signal, which is an analog signal, to a digital baseband signal, and inputs the obtained digital baseband signal to the reception control unit 1102. The digital baseband signal obtained as described above corresponds to the in-phase component (in-phase signal) I(t) indicated in Expression (6).

The reception control unit 1102 generates the DC component (quadrature signal) Q(t) by carrying out a Hilbert transformation on the in-phase component I(t). Furthermore, the reception control unit 1102 generates the complex baseband signal r(t) from the in-phase component I(t) and the DC component Q(t) using Expression (8). The generated complex baseband signal r(t) is passed to the data processing unit 1093. Note that as described above, the DC component Q(t) may be generated using a DC modulator instead of the mixer 1042.

The data processing unit 1093 subjects the received complex baseband signal r(t) to the processing described using FIGS. 2 to 8, i.e., to the process of estimating the incoming direction of the received electric wave 1007. Furthermore, the data processing unit 1106 executes an imaging process (generates an image) for the target object 1001. The data processing unit 1106 then outputs the result of the processing, i.e., the estimated incoming direction and the generated image, to the output unit 1094. The output unit 1094 is a display device that displays the result of the processing in a screen, for example.

Although one each of the transmission unit 1091 and the reception unit 1092 are indicated in the example illustrated in FIG. 9, the present first embodiment is not limited to this example. In the present first embodiment, the object detection apparatus 1000 may include a plurality of each of the transmission unit 1091 and the reception unit 1092. Additionally, the data processing unit 1093 and the output unit 1094 may be built into the transmission unit 1091 or the reception unit 1092.

Device Operations

Next, operations of the object detection apparatus 1000 according to the first embodiment of the present invention will be described using FIG. 7. FIG. 7 is a flowchart illustrating operations of the object detection apparatus 100 according to the first embodiment of the present invention. The following descriptions will refer to FIGS. 1 to 8 as appropriate. In the present first embodiment, an object detection method is realized by causing the object detection apparatus to operate. As such, the following descriptions of the operations of the object detection apparatus 1000 will be given in place of descriptions of the object detection method according to the present first embodiment.

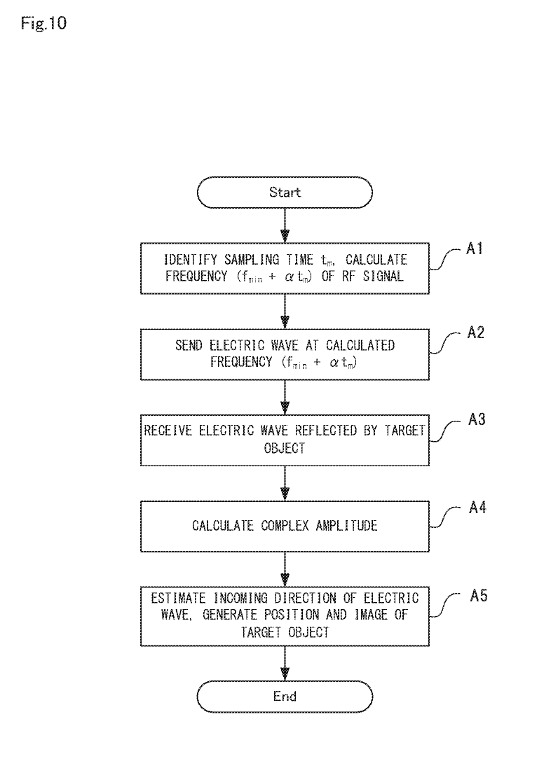

As illustrated in FIG. 10, first, in the transmission unit 1091, the transmission control unit 1104 identifies the current sampling time tₘ, and calculates a frequency (fₘᵢₙ+αtₘ) of the RF signal sent by the transmission antenna 1003 (step A1).

Next, the transmission control unit 1104 generates and outputs a control signal for the oscillator 1103 so that the RF signal having the frequency (fₘᵢₙ+αtₘ) is sent from the transmission antenna 1003, and as a result, an RF signal having a frequency of (fₘᵢₙ+αtₘ) is sent from the transmission antenna 1003 (step A2).

Specifically, the transmission control unit 1104 sends a control signal to the oscillator 1103 so that the output frequency of the oscillator 1103 is (fₘᵢₙ+αtₘ), and the oscillator 1103 outputs the RF signal having a carrier frequency of (fₘᵢₙ+αtₘ). As a result, the RF signal is amplified by the power amplifier 1071 and sent from the transmission antenna 1003.

Additionally, the RF signal output by the oscillator 1103 is also sent to the mixer 1042 in the reception unit 1092 via the coupler 1075.

Next, in the reception unit 1092, the reception antenna 1004 receives the electric wave (RF signal) 1007 reflected by the target object 1001 (step A3).

Next, the reception control unit 1102 calculates the complex baseband signal r(t) from the in-phase component I(t) of the baseband signal obtained from the received RF signal (step A4).

Specifically, in step A4, the RF signal 1007 received through the reception antenna 1004 is first amplified by the low-noise amplifier 1041 and is then input to the mixer 1042. The mixer 1042 mixes the reception RF signal amplified by the low-noise amplifier 1041 with the RF signal output from the transmission unit 1091 via the coupler 1075 as the LO signal, and generates the baseband signal (the in-phase component I(t)). The baseband signal (the in-phase component I(t)) is input to the analog-digital converter 1044 via the filter 1043 and converted into a digital signal. The reception control unit 1102 calculates the complex baseband signal r(t) from the baseband signal (in-phase component I(t)) converted to digital format.

Next, the data processing unit 1093 estimates the incoming direction of the received electric wave 1007 using the complex baseband signal r(t), and furthermore executes an imaging process for the target object 1001 using the estimation result (step A5).

In the present first embodiment, the processing of steps A1 to A5 are repeated, and the result of the repeated processing is displayed in a screen by the output unit 1094.

### Effects of First Embodiment

According to the present first embodiment as described above, an object can be detected accurately without preparing a large number of reception antennas and receivers as with the conventional techniques. Additionally, because it is not necessary to increase the number of reception antennas, an increase in the apparatus cost, size, and weight is suppressed.

Additionally, in the present first embodiment, the FM-CW method is used as the method for transmitting and receiving the electric wave. It is therefore not necessary to provide an oscillator in the reception unit 1092, which also makes it possible to reduce the apparatus cost. Furthermore, because the reception unit 1092 does not require an oscillator, it is not necessary to ensure synchronization between the oscillator 1103 in the transmission unit 1091 and the oscillator in the reception unit 1092; as a result, synchronization errors between the transmission unit 1091 and the reception 1092, and a drop in detection accuracy caused thereby, do not arise.

Note that the object detection apparatus 1000 according to the first embodiment is used in the second embodiment and the third embodiment described below. The processing carried out in the first embodiment is used in a process for estimating the position (and particularly, in a one-dimensional direction) of the target object 1001 according to a second embodiment, and in a process for displaying the arrangement state and shape of the target object 1001 in a two-dimensional image according to a third embodiment. These processes are carried out by the data processing unit 1093.

### Second Embodiment

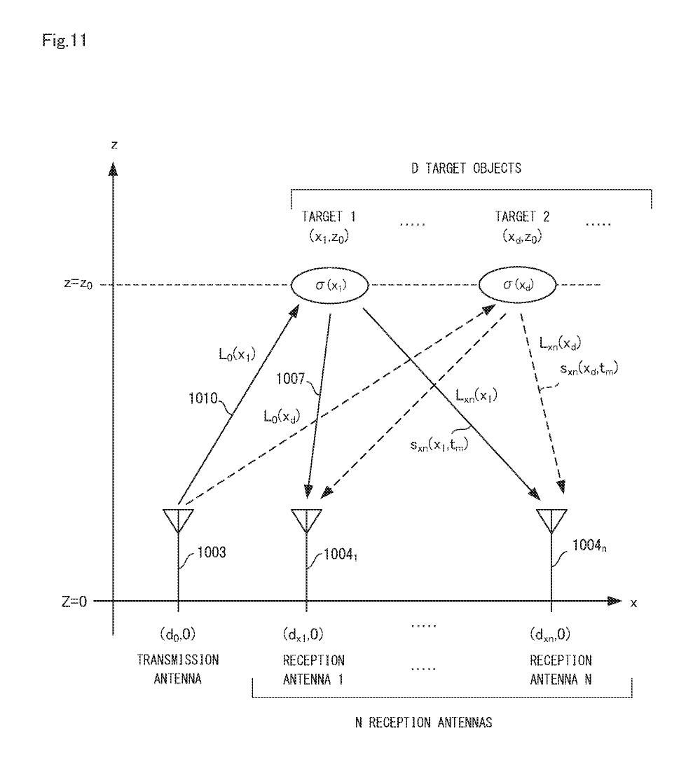

An object detection apparatus and an object detection method according to a second embodiment of the present invention will be described next, with reference to FIGS. 11 to 13.

The present second embodiment describes an example of estimating the position, and particularly the one-dimensional direction, of a target object using the object detection apparatus 1000 described in the first embodiment. As such, in the present second embodiment too, the object detection apparatus includes the transmission unit 1091, the reception unit 1092, and the data processing unit 1093 illustrated in FIGS. 1 and 9. However, the present second embodiment differs from the first embodiment in terms of the number of reception units 1092. This will be described in detail below.

FIG. 11 is a diagram illustrating the configuration and principles of operation of the object detection apparatus according to the second embodiment of the present invention. First, in the present second embodiment, the object detection apparatus includes N reception units for a single transmission unit. Accordingly, as illustrated in FIG. 11, in the present second embodiment, the object detection apparatus includes a single transmission antenna 1003, and N reception antennas 1004₁, . . . , 1004ₙ, . . . , 1004_{N}. These will be referred to as the “reception antennas 1004” in the following when not indicating a specific reception antenna.

Furthermore, in the present second embodiment, each reception antenna is arranged along a direction that takes the transmission antenna as a reference, as illustrated in FIG. 11. Specifically, the transmission antenna 1003 and each reception antenna 1004 are arranged on the x axis (z=0). In (x,z) coordinates, the position of the transmission antenna 1003 is (d₀,0). The positions of the N reception antennas 1004 are (dₓ₁,0), (dₓ₂,0), . . . , (d_{xN},0), respectively.

Note that the object detection apparatus can operate even when the number of reception antennas is the minimum of 1. However, a case where there are N reception antennas will be given here to make the theory general. It is also assumed that the target objects 1001 are arranged at D positions (x₁,z₀), (x₂,z₀), . . . , (x_{D},z₀) on an axis where z=z₀. To simplify the descriptions, it is assumed that the positions of the transmission antenna 1003, the reception antennas 1004, and the target objects 1001 are fixed at the above-described positions.

In this configuration, the data processing unit estimates the incoming direction of the electric wave from a measurement value of the baseband signal received by each of the reception antennas 1004. Additionally, on the basis of the estimated incoming direction of the electric wave, the data processing unit identifies an intensity distribution of the electric wave, and on the basis of the identified intensity distribution, detects the position of each target object 1001 in one direction.

The data processing unit also constructs a time-virtual array from the measurement values of the baseband signal in each sampling time, and calculates a correlation matrix of the time-virtual array. More specifically, the data processing unit constructs sub arrays of the time-virtual array from the measurement values of the baseband signals in different sampling times, calculates a correlation matrix for each sub array, and calculates an average value of the correlation matrix for each sub array. Then, on the basis of the average value of the correlation matrix, the data processing unit finds an evaluation function reflecting the position of the target object 1001, and generates an image of the target object 1001 from the evaluation function that has been found. The processing carried out by the object detection apparatus according to the present second embodiment will be described in detail hereinafter.

First, in the present second embodiment, an FM-CW signal is sent from the transmission antenna 1003, in the same manner as in the first embodiment.

The reception antenna 1004 receives the reflected wave 1007 from the target object 1001.

Here, a complex baseband signal obtained from a reflected wave 1007 reflected by a dth (where d=1, 2, . . . , D) target object 1001_{d} and received by an nth reception antenna 1004ₙ is indicated by sₓₙ(x_{d},tₘ). The subscript “xn” indicates that the signal has been received by the nth reception antenna 1004ₙ arranged in the x axis direction. Additionally, here, a complex baseband signal sₓₙ(x_{d},tₘ) in the sampling time tₘ (where m=1, 2, . . . , M) is the data to be acquired.

The signal actually received by each reception antenna 1004ₙ is a combination of the reflected waves 1007 from all of the target objects 1001_{d} (where d=1, 2, . . . , D), and a complex amplitude sₓₙ(x_{d},tₘ) of the reflected wave 1007 from an individual object is an unknown number. Assuming the complex amplitude of the signal actually measured by the reception antenna 1004ₙ is sₓₙ′(tₘ), the relationship between sₓₙ′(tₘ) and sₓₙ(x_{d},tₘ) is as follows.

$$\begin{matrix}[ Expression 18 ] & \\ {s}_{xn}^{′} ( {t}_{m} ) = {\sum }_{d = 1}^{D} {s}_{xn} ( {x}_{d} , {t}_{m} ) , \\ ( n = 1 , 2 , … , N , m = 1 , 2 , … , M ) & ( 18 )\end{matrix}$$

Note that sₓₙ′(tₘ) in Expression (18) corresponds to the complex baseband signal r(t) in Expression (8), described in the first embodiment.

Next, the complex amplitude sₓₙ(x_{d},tₘ) of the reflected wave 1007 reflected by each target object 1001_{d} (where d=1, 2, . . . , D) and received by the nth reception antenna 1004ₙ is analyzed in detail. A distance L₀(x_{d}) from the transmission antenna 1003 to the target object 1001_{d}, and a distance Lₓₙ(x_{d}) from the nth reception antenna 1004ₙ to the target object 1001_{d}, are given by the following Expressions (19) and (20).

[Expression 19]

L₀(x_{d})=\sqrt{(x_{d}−d₀)²+z₀²}, (19)

[Expression 20]

Lₓₙ(x_{d})=\sqrt{(x_{d}−dₓₙ)²+z₀²}, (20)

The following relationship holds true between the complex amplitude s₀ of the RF signal 1010 sent from the transmission antenna 1003, and the complex amplitude sₓₙ(x_{d},tₘ) obtained from the reflected wave 1007 received by the nth reception antenna 1004ₙ.

$$\begin{matrix}[ Expression 21 ] & \\ {s}_{xn} ( {x}_{d} , {t}_{m} ) = {s}_{0} \cdot σ ( {x}_{d} ) exp [ - j \frac{2 π α {t}_{m}}{c} \{ {L}_{0} ( {x}_{d} ) + {L}_{xn} ( {x}_{d} ) \} ] , & ( 21 )\end{matrix}$$

In Expression (21), σ(x_{d}) is an unknown number expressing the reflectance of the target object 1001_{d}. The exponent item on the right side in Expression (21) expresses a phase shift in the electric wave arising in the path from the transmission antenna 1003 to the reception antenna 1004ₙ via the target object 1001_{d}. The following Expression (22) is obtained by substituting Expression (21) in Expression (18).

$$\begin{matrix}[ Expression 22 ] & \\ {s}_{xn}^{′} ( {t}_{m} ) = {s}_{0} {\sum }_{d = 1}^{D} σ ( {x}_{d} ) exp [ - j \frac{2 π α {t}_{m}}{c} \{ {L}_{0} ( {x}_{d} ) + {L}_{xn} ( {x}_{d} ) \} ] , & ( 22 )\end{matrix}$$

The process (analysis) carried out by the data processing unit will be described next, but first, several signals will be defined. Using the signal sₓₙ′(tₘ) (where n=1, 2, . . . , N and m=1, 2, . . . , M) on the left side of Expression (11), a measurement signal vector sₓ is defined through the following Expression (23).

[Expression 23]

sₓ≡s′ₓ₁(t₁), s′ₓ₁(t₂), . . . , s′ₓ₁(t_{M}), . . . , s′_{xN}(t₁), s′_{xN}(t₂), . . . , s′_{xN}(t_{M})]^{T}, (23)

The superscript [ ]^{T} represents the transpose of a vector or a matrix. Next, using the exponent item included on the right side of Expression (11), the direction matrix A is defined as indicated in the following Expression (24).

$$\begin{matrix}[ Expression 24 ] & \\ A ≡ ( \begin{matrix}{A}_{1} \\ {A}_{2} \\ ⋮ \\ {A}_{N}\end{matrix} ) , \\ {A}_{n} ≡ ( {a}_{n} ( {x}_{1} ) , {a}_{n} ( {x}_{2} ) , … , {a}_{n} ( {x}_{D} ) ) , \\ {a}_{n} ( {x}_{d} ) ≡ {[ {a}_{d ( n ) ( 1 )} , {a}_{d ( n ) ( 2 )} , … , {a}_{d ( n ) ( M )} ]}^{T} , \\ {a}_{d ( n ) ( m )} ≡ exp [ - j \frac{2 π α {t}_{m}}{c} \{ {L}_{x 0} ( {x}_{d} , {y}_{d} ) + {L}_{xn} ( {x}_{d} , {y}_{d} ) \} ] , \\ ( n = 1 , 2 , … , N , m = 1 , 2 , … , M , d = 1 , 2 , … , D ) & ( 24 )\end{matrix}$$

In Expression (24), the size of the matrix A is MN×D, the size of a matrix Aₙ is M×D, and the size of a vector aₙ(x_{d}) is M×1. Note that in the present specification, the size of a matrix is written as a vertical×horizontal number of elements. Using the variables s₀ and σ(x_{d}) on the right side of Expression (11), a desired signal vector s is defined by the following Expression (25).

[Expression 25]

s≡s₀[σ(x₁), σ(x₂), . . . , σ(x_{D})]^{T}, (25)

A goal of the present second embodiment is to determine an evaluation function reflecting the x_{d} dependence of the desired signal vector s in measurement by the reception antenna 1004 (i.e., σ(x_{d})). The distribution and shapes of the target objects 1001 are detected from the x_{d} dependence of the desired signal vector s. The relationship in the above Expression (22) can be expressed through the following Expression (26), using the measurement signal vector sₓ, the direction matrix A, and the desired signal vector s.

[Expression 26]

sₓ=As+n(t), (26)

In expanding Expression (22) to Expression (26), an MN×1-dimensional vector n(t) that takes noise (a random number) as an element is newly added to the right side of Expression (26). The addition of the noise (random number) n(t) is done artificially by the data processing unit. Additionally, a number of points of time t defining n(t) (snapshot number) with respect to a single sampling time tₘ is greater than 1.

As will be described later, the matrix A being full rank is a condition for applying the MUSIC method. Adding the noise vector n(t) has an effect of effectively breaking down the dependency of the column vectors and the row vectors in the matrix A and bringing the matrix A closer to full rank.

In the present second embodiment, a measurement signal vector sₓ(t) defined by Expression (23) is received by the reception antenna 1004. The data processing unit calculates a correlation matrix Rₓ, indicated in the following Expression (27), using the received measurement signal vector sₓ.

$$\begin{matrix} [ Expression 27 ] & \\ \begin{matrix}{R}_{x} ≡ {E [ {s}_{x} \cdot {s}_{x}^{H} ]}^{T} , \\ = ( \begin{matrix}E [ {\vert {s}_{x 1}^{′} ( {t}_{1} ) \vert}^{2} ] & … & E [ {s}_{x 1}^{′} ( {t}_{1} ) {s}_{x 1}^{{′}^{*}} ( {t}_{M} ) ] & … & E [ {s}_{x 1}^{′} ( {t}_{M} ) {s}_{xN}^{{′}^{*}} ( {t}_{1} ) ] & … & E [ {s}_{x 1}^{′} ( {t}_{M} ) {s}_{xN}^{{′}^{*}} ( {t}_{M} ) ] \\ ⋮ & & ⋮ & & ⋮ & & ⋮ \\ E [ {s}_{x 1}^{′} ( {t}_{M} ) {s}_{x 1}^{{′}^{*}} ( {t}_{1} ) ] & … & E [ {\vert {s}_{x 1}^{′} ( {t}_{M} ) \vert}^{2} ] & … & E [ {s}_{x 1}^{′} ( {t}_{M} ) {s}_{xN}^{{′}^{*}} ( {t}_{1} ) ] & … & E [ {s}_{x 1}^{′} ( {t}_{M} ) {s}_{xN}^{{′}^{*}} ( {t}_{M} ) ] \\ ⋮ & & ⋮ & & ⋮ & & ⋮ \\ E [ {s}_{xN}^{′} ( {t}_{1} ) {s}_{x 1}^{{′}^{*}} ( {t}_{1} ) ] & … & E [ {s}_{x N}^{′} ( {t}_{1} ) {s}_{x 1}^{{′}^{*}} ( {t}_{M} ) ] & … & E [ {\vert {s}_{xN}^{′} ( {t}_{1} ) \vert}^{2} ] & … & E [ {s}_{xN}^{′} ( {t}_{M} ) {s}_{xN}^{{′}^{*}} ( {t}_{M} ) ] \\ ⋮ & & ⋮ & & ⋮ & & ⋮ \\ E [ {s}_{x N}^{′} ( {t}_{M} ) {s}_{x 1}^{{′}^{*}} ( {t}_{1} ) ] & & E [ {s}_{xN}^{′} ( {t}_{M} ) {s}_{x 1}^{{′}^{*}} ( {t}_{M} ) ] & … & E [ {s}_{xN}^{′} ( {t}_{M} ) {s}_{x N}^{{′}^{*}} ( {t}_{1} ) ] & … & E [ {\vert {s}_{xN}^{′} ( {t}_{M} ) \vert}^{2} ]\end{matrix} ) ,\end{matrix} & ( 27 )\end{matrix}$$

E[ ] in Expression (27) expresses an average across the number of points of the time t (snapshot number) defining the noise (random number) vector n(t).

By substituting the above Expression (26) in the definition of the correlation matrix Rₓ indicated by Expression (27), the relationship between the correlation matrix Rₓ and the direction matrix A is derived from the following Expression (28).

$$\begin{matrix}[ Expression 28 ] & \\ {R}_{x} = {ASA}^{H} + {P}_{M} I , \\ S ≡ {E [ s \cdot {s}^{H} ]}^{T} , \\ = {\vert {s}_{0} \vert}^{2} \cdot ( \begin{matrix}{\vert σ ( {x}_{1} ) \vert}^{2} & σ ( {x}_{1} ) {σ}^{*} ( {x}_{2} ) & … & σ ( {x}_{1} ) {σ}^{*} ( {x}_{D} ) \\ σ ( {x}_{2} ) {σ}^{*} ( {x}_{1} ) & {\vert σ ( {x}_{2} ) \vert}^{2} & & σ ( {x}_{2} ) {σ}^{*} ( {x}_{D} ) \\ ⋮ & ⋮ & & ⋮ \\ σ ( {x}_{D} ) {σ}^{*} ( {x}_{1} ) & σ ( {x}_{D} ) {σ}^{*} ( {x}_{2} ) & … & {\vert σ ( {x}_{D} ) \vert}^{2}\end{matrix} ) , \\ ( n = 1 , 2 , … , N , m = 1 , 2 , … , M , d = 1 , 2 , … , D ) & ( 28 )\end{matrix}$$

In Expression (28), P_{N} represents noise power, and I represents an MN×MN dimensional unit matrix. The superscript H represents a complex conjugate transpose. The size of the correlation matrix Rₓ, the matrix A, and the matrix S are MN×MN dimensions, MN×D dimensions, and D×D dimensions, respectively.

Incidentally, as described in Non-Patent Document 1, it is known that applying the MUSIC method to a system in which Expressions (26) and (28) are established makes it possible to calculate an evaluation function P_{MU}(x) reflecting the x dependence (i.e., σ(x)) of the intensity of the desired signal vector s.

However, the matrix A and the matrix S in Expression (28) being full rank is a condition for applying the MUSIC method. “Full rank” refers to the rank of the matrix matching the size of the matrix (the lesser of the number of rows and the number of columns), and is defined as all of the row vectors and column vectors in the matrix having linear independence.

In the direction matrix A, each column vector is a function of a different position x_{d}, and thus each column vector is independent, so the matrix is full rank. Looking at the elements in the matrix S, when σ(xᵢ)=σ(xⱼ) (i≠j), the row vectors of the ith row and the jth row in the matrix S have the same value and thus have linear dependence, which drops the rank by one, so the matrix is not full rank. Although Expression (17) can be viewed as a simultaneous equation, the rank of the matrix S dropping is equivalent to the number of independent equations dropping, which makes it difficult to obtain the information of the desired unknown number σ(x_{d}) (where d=1, 2, . . . , D).

The following describes a method for returning the matrix S to full rank using the sub array concept. A virtual array is constructed by treating a single frequency as a single antenna in the present second embodiment as well, as was described in the present embodiment.

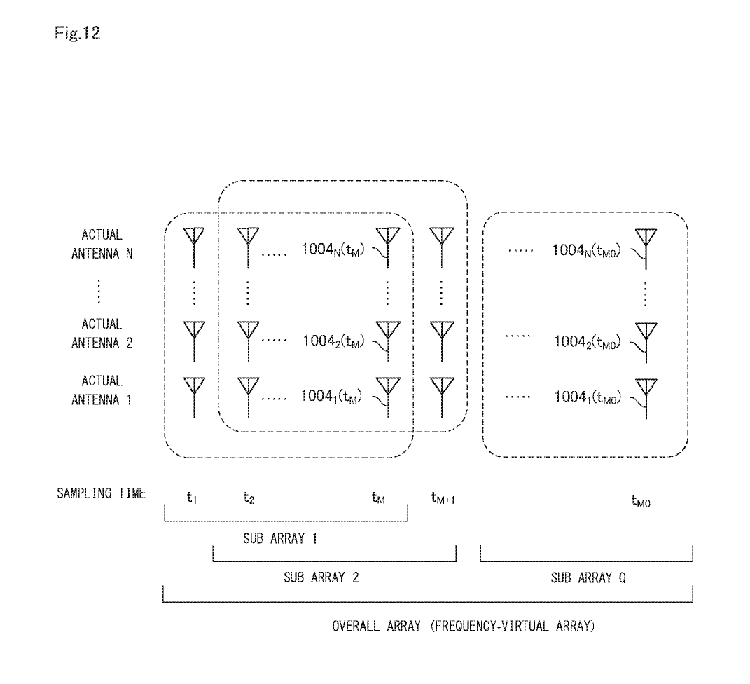

In the present second embodiment, all of the data measured while varying the sampling time is taken as an overall array, whereas data from each of the sampling times divided into groups is taken as sub arrays, as illustrated in FIG. 12. FIG. 12 is a diagram illustrating the concept of the sub array used in the object detection apparatus according to the second embodiment of the present invention.

As illustrated in FIG. 12, the overall array is constituted by measurement data from M₀ frequencies, whereas the sub arrays are constituted by measurement data from M (where M₀>M) frequencies. Assuming the number of sub arrays is Q, the relationship Q=M₀−M+1 holds true. A measurement signal vector s_{xq} of a sub array q (where q=1, 2, . . . , Q) is defined by the following Expression (29).

[Expression 29]

sₓ^{q}≡[sₓ₁(t_{q}), sₓ₁(t_{q+1}), . . . , sₓ₁(t_{q+M-1}), . . . , s_{xN}(t_{q}), s_{xN}(t_{q+1}), . . . , s_{xN}(t_{q+M-1})]^{T}, (29)

At this time, in the measurement signal vector s_{xq} of the sub array q in Expression (29), a relationship given by the following Expression (30) holds true between the direction matrix A of Expression (24) and the desired signal vector s of Expression (14).

$$\begin{matrix}[ Expression 30 ] & \\ {S}_{x}^{q} = ( \begin{matrix}{A}_{1} {B}_{1}^{q - 1} \\ {A}_{2} {B}_{2}^{q - 1} \\ ⋮ \\ {A}_{N} {B}_{N}^{q - 1}\end{matrix} ) s + n ( t ) , \\ {B}_{n} ≡ \cdot ( \begin{matrix}{b}_{n 1} & 0 & … & & 0 \\ 0 & {b}_{n 2} & & & 0 \\ ⋮ & ⋮ & & & ⋮ \\ & & & & \\ 0 & 0 & … & & {b}_{nD}\end{matrix} ) . \\ {b}_{nd} ≡ exp [ - j \frac{2 π αΔ t}{c} \{ {L}_{0} ( {x}_{d} ) + {L}_{xn} ( {x}_{d} ) \} ] , & ( 30 )\end{matrix}$$

Here, sampling times t₁, t₂, . . . , t_{M} are equal intervals, and the interval thereof (sampling period) is represented by Δt. In other words, tₘ=m·Δt (where m=1, 2, . . . , M). A correlation matrix R_{xq} of the sub array q is calculated as indicated by the following Expression (31).

$$\begin{matrix}[ Expression 31 ] & \\ {R}_{x}^{q} ≡ {E [ {s}_{x}^{q} \cdot {s}_{x}^{qH} ]}^{T} , = {A}^{′} {S}^{′} {A}^{′ H} + {P}_{N} I , \\ {A}^{′} ≡ ( \begin{matrix}{A}_{1} & 0 & … & 0 \\ 0 & {A}_{2} & & ⋮ \\ ⋮ & & ⋱ & 0 \\ 0 & & 0 & {A}_{N}\end{matrix} ) , \\ {S}^{′} ≡ ( \begin{matrix}{S}_{11}^{′} & {S}_{12}^{′} & … & {S}_{1 N}^{′} \\ {S}_{21}^{′} & {S}_{22}^{′} & … & {S}_{2 N}^{′} \\ ⋮ & ⋮ & & ⋮ \\ {S}_{N 1}^{′} & {S}_{N 2}^{′} & … & {S}_{NN}^{′}\end{matrix} ) , \\ {S}_{ij}^{′} ≡ {B}_{i}^{q - 1} {S ( {B}_{j}^{q - 1} )}^{H} , & ( 31 )\end{matrix}$$

In Expression (31), the sizes of the correlation matrix R_{xq}, a matrix A′, and a matrix S′ are NM×NM dimensions, NM×ND dimensions, and ND×ND dimensions, respectively. Next, an average Rₓ′ of the correlation matrices of all the sub arrays q (where q=1, 2, . . . , Q) is calculated. A relationship between the average correlation matrix Rₓ′ of all the sub arrays and the direction matrix A is calculated as indicated by the following Expression (32).

$$\begin{matrix}[ Expression 32 ] & \\ {R}_{x}^{′} ≡ \frac{1}{Q} {\sum }_{q = 1}^{Q} {R}_{x}^{q} = {A}^{′} {S}^{″} {A}^{′ H} + {P}_{N} I , \\ {S}^{″} ≡ ( \begin{matrix}{S}_{11}^{″} & {S}_{12}^{″} & … & {S}_{1 N}^{″} \\ {S}_{21}^{″} & {S}_{22}^{″} & … & {S}_{2 N}^{″} \\ ⋮ & ⋮ & & ⋮ \\ {S}_{N 1}^{″} & {S}_{N 2}^{″} & … & {S}_{NN}^{″}\end{matrix} ) , \\ {S}_{ij}^{″} ≡ \frac{1}{Q} {\sum }_{q = 1}^{Q} {B}_{i}^{q - 1} {S ( {B}_{j}^{q - 1} )}^{H} , & ( 32 )\end{matrix}$$

The correlation matrix Rₓ′ in Expression (32) has a shape of A′S″A′^{H}, in the same manner as the correlation matrix of Expression (17). Thus, if the matrices A′ and S″ are full rank, applying the MUSIC method to the correlation matrix Rₓ′, an evaluation function P_{MU}(x) reflecting the x dependence of the intensity of the desired signal vector s (i.e., σ(x)) can be calculated.

Direction matrices A₁, A₂, . . . , A_{N} are both independent and full rank, and thus the matrix A′ given by Expression (31) is also full rank.

The matrix S″ will be considered next. Consider a state where in Expression (17), all the target objects have the same state of reflectance, i.e., a state where σ=σ(x₁)=σ(x₂)= . . . =σ(x_{D}), with σ as a constant. At this time, the rank of the matrix S is 1, which is the strictest state when applying the MUSIC method. Even in this state, the matrix S″ of Expression (21) is full rank if the conditions are met. The following Expression (33) indicates the result of calculating the matrix S′ in Expression (32) when σ=σ(x₁)=σ(x₂)= . . . =σ(x_{D}).

$$\begin{matrix}[ Expression 33 ] & \\ {S}_{ij}^{″} = \frac{σ E ⌊ {\vert {s}_{0} ( t ) \vert}^{2} ⌋}{Q} {C}_{i} {C}_{j}^{H} , \\ {C}_{i} ≡ \cdot ( \begin{matrix}1 & {b}_{i 1} & {b}_{i 1}^{2} & … & {b}_{i 1}^{Q - 1} \\ 1 & {b}_{i 2} & {b}_{i 2}^{2} & … & {b}_{i 2}^{Q - 1} \\ ⋮ & ⋮ & ⋮ & & ⋮ \\ & & & & \\ 1 & {b}_{iD} & {b}_{iD}^{2} & … & {b}_{i D}^{Q - 1}\end{matrix} ) , & ( 33 )\end{matrix}$$

In a matrix Cᵢ, if bᵢᵤ=bᵢᵥ (u≠v), the row vectors of the uth row and the vth row of the matrix C have the same value and have linear dependence, and thus the rank drops by 1 and is no longer the full rank. On the other hand, as can be seen from Expression (30), b_{id} is a function of the distances L₀(x_{d}) and (Lₓ(x_{d}), and these distances take on different values if the position x_{d} is different; bᵢᵤ=bᵢᵥ (u≠v) therefore does not hold true, and Cᵢ is full rank.

The matrix size of Cᵢ is D×Q, and thus the rank of Cᵢ is the lower of D and Q. Accordingly, if Q≥D, the rank of Cᵢ is D, the rank of S″ᵢⱼ also becomes D, and the conditions for full rank are satisfied. Each S″ᵢⱼ is independent, and thus S″ is full rank.

The matrix S in Expression (28) is not full rank due to the condition in which the reflectance σ(x_{d}) takes the same value even when the position x_{d} is different. On the other hand, the matrix S″ is guaranteed to have full rank on the basis of the property by which the distances L₀(x_{d}) and Lₓ(x_{d}) will absolutely change if the position x_{d} changes.

When Q<D, the rank of S″ is Q, and the rank of S″ rises each time the number Q of sub arrays is increased. This can be interpreted as each sub array being a mutually-independent collection of signals, and thus increasing the number Q of sub arrays increases the independent signal collections by one as well, which increases the rank of the matrix S″.

If the relationship of Q=M₀−M+1 and another application condition of the MUSIC method, namely MN≥D+1, are also included, the condition of the necessary number M₀ of frequencies is given by the following Expression (34). In other words, the necessary number of frequencies M₀ increases in proportion with the number D of positions to be detected.

$$\begin{matrix}[ Expression 34 ] & \\ {M}_{0} \geq D - 1 + \frac{D + 1}{N} \approx ( 1 + \frac{1}{N} ) D , & ( 34 )\end{matrix}$$

In Non-Patent Document 1, the incoming direction is estimated by applying the MUSIC method to the correlation matrix of a typical array antenna. In the present second embodiment, the evaluation function P_{MU}(x) reflecting the x dependence (i.e., σ(x)) of the intensity of the desired signal vector s is calculated by applying the MUSIC method (by the same method as formally applied to a typical array antenna) to the average correlation matrix Rₓ′ of all the sub arrays calculated by Expression (21). At this time, the evaluation function P_{MU}(x) is given by the following Expression (35).

$$\begin{matrix}[ Expression 35 ] & \\ {P}_{MU} ( x ) = \frac{{a}^{H} ( x ) a ( x )}{{a}^{H} ( x ) {E}_{N} {E}_{N}^{H} a ( x )} , & ( 35 )\end{matrix}$$

Here, a(x) is a column vector of the direction matrix A defined in Expression (34). E_{N} is given by the following Expression (36).

[Expression 36]

E_{N}≡[e_{D+1}, e_{D+2}, . . . , e_{MN}], (36)

Here, among the eigenvectors of the correlation matrix Rₓ′, the eigenvalues of the vector eₖ (where k=D+1, D+2, . . . , MN) are equal to the noise power. According to the MUSIC method, the evaluation function P_{MU}(x) in Expression (35) gives a peak at the position x_{d} of the target object 1001_{d} (where d=1, 2, . . . , D).

Accordingly, the position x_{d} of the target object 1001_{d} (where d=1, 2, . . . , D) can be determined from the position x at which the evaluation function P_{MU}(x) gives a peak value. When applying the MUSIC method, eigenvectors {e_{D+1}, e_{D+2}, . . . , e_{MN}} of (MN−D) noise spaces are used, but a minimum of one thereof is required, and thus it is necessary that MN−D≥1, i.e., MN≥D+1, be satisfied.

In the above-described example, the position x_{d} of the target object 1001_{d} (where d=1, 2, . . . , D) is detected using the MUSIC method. However, in the present second embodiment, it is also possible to calculate an evaluation function reflecting the x dependence (i.e., σ(x)) of the intensity of the desired signal vector s(t) by applying the beam former method, the Capon method, and the linear prediction method (described in Non-Patent Document 1 as the same method as formally applied to a typical array antenna) to the correlation matrix Rₓ′. An evaluation function P_{BF}(x) based on the beam former method according to the present second embodiment is given by the following Expression (37).

$$\begin{matrix}[ Expression 37 ] & \\ {P}_{BF} ( x ) = \frac{{a}^{H} ( x ) {R}_{x}^{′} a ( x )}{{a}^{H} ( x ) a ( x )} , & ( 37 )\end{matrix}$$

Furthermore, an evaluation function P_{CP}(x) based on the Capon method according to the present second embodiment is given by the following Expression (38).

$$\begin{matrix}[ Expression 38 ] & \\ {P}_{CP} ( x ) ≡ \frac{1}{{a}^{H} ( x ) {R}_{x}^{′ - 1} a ( x )} , & ( 38 )\end{matrix}$$

Further still, an evaluation function P_{LP}(x) based on the linear prediction method according to the present second embodiment is given by the following Expression (39).

$$\begin{matrix}[ Expression 39 ] & \\ {P}_{LP} ( x ) ≡ \frac{1}{{\vert {W}_{LP}^{H} a ( x ) \vert}^{2}} , \\ {W}_{LP} ≡ {R}_{x}^{′ - 1} T , T ≡ {[ 1 , 0 , … , 0 ]}^{T} , & ( 39 )\end{matrix}$$

The above-described evaluation functions P_{BF}(x), P_{CP}(x), and P_{LP}(x) also take on peak values at the position x_{d} of the target object 1001_{d} (where d=1, 2, . . . , D), in the same manner as the evaluation function P_{MU}(x) obtained through the MUSIC method. Accordingly, the position x_{d} of the target object 1001_{d} (where d=1, 2, . . . , D) can be determined from the position x at which the evaluation function gives a peak value.

The process disclosed in the present second embodiment, i.e., the process of calculating the evaluation function from the result of measuring the reflected wave and determining the position of the target object from the evaluation function, is executed by the data processing unit 1093 illustrated in FIG. 9. The process of calculating the evaluation function in the present second embodiment and searching for the peak of the evaluation function is performed by controlling the phase shifter 1031 and the adder 1032 in the first embodiment, and corresponds to a process of searching for the beam direction where the reception signal intensity is maximum.

Additionally, in the present second embodiment, it is possible to detect only the position information x_{d} (that is, the position in the one-dimensional direction) of the coordinates (that is, the x axis) in the direction connecting the transmission unit and the reception unit. This is because the object detection apparatus including the transmission unit and the reception unit has rotational symmetry with respect to the x axis, and thus even if coordinate values of the target object 1001 aside from those on the x axis are different, this cannot be distinguished. A method for detecting the position information of coordinates aside from those on the x axis will be described later in the third embodiment.

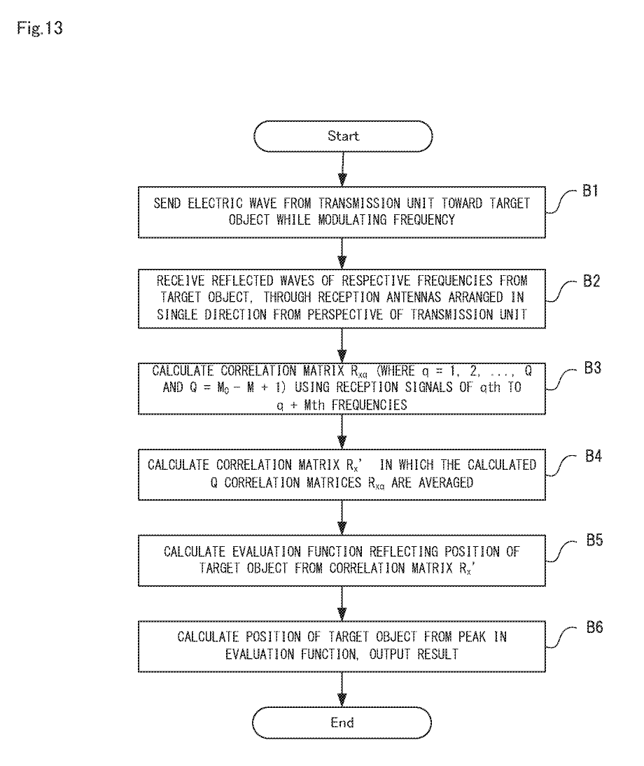

Next, the operations of the object detection apparatus according to the present second embodiment will be described using FIG. 13. FIG. 13 is a flowchart illustrating operations of the object detection apparatus according to the second embodiment of the present invention. In the present second embodiment as well, an object detection method is realized by causing the object detection apparatus to operate. As such, the following descriptions of the operations of the object detection apparatus 1000 will be given in place of descriptions of the object detection method according to the present second embodiment.

As illustrated in FIG. 13, first, in the object detection apparatus, the transmission unit emits an electric wave toward the target object while varying the frequency (step B1).

Next, the plurality of reception units receive the reflected waves of the respective frequencies from the target object, through the corresponding reception antennas (step B2). The reception antennas are arranged in a single direction from the perspective of the transmission unit.

Next, the data processing unit calculates the correlation matrix R_{xq} (where q=1, 2, . . . , Q and Q=M₀−M+1) using the reception signals from the qth to the q+Mth sampling times (step B3).

Next, the data processing unit calculates the correlation matrix Rₓ′ in which the calculated Q correlation matrices R_{xq} (where q=1, 2, . . . , Q) are averaged (step B4), and furthermore calculates the evaluation function reflecting the position of the target object from the correlation matrix Rₓ′ (step B5).

Then, the data processing unit calculates the position of the target object from the peak in the evaluation function (step B6). The calculation result is output to the output unit.

As described thus far, according to the present second embodiment, the one-dimensional direction of a target object can be estimated without using a large number of reception antennas. Additionally, the effects described in the first embodiment can be achieved by the present second embodiment as well.

### Third Embodiment

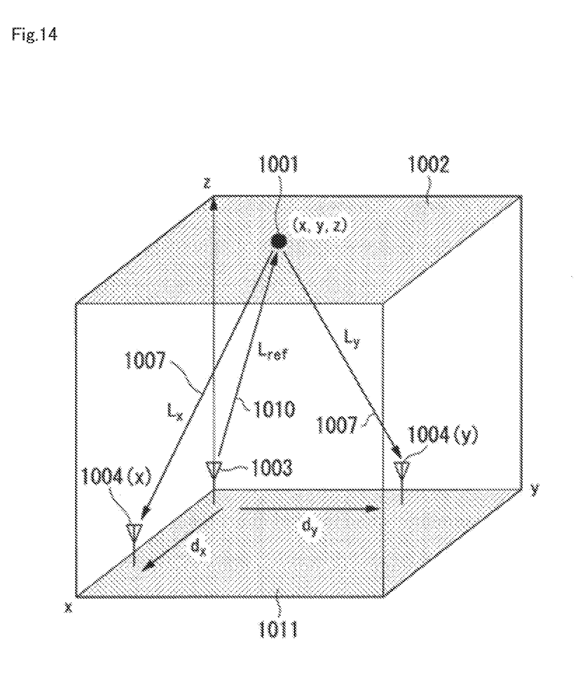

An object detection apparatus and an object detection method according to a third embodiment of the present invention will be described next, with reference to FIGS. 14 to 18.

The present third embodiment illustrates an example in which a two-dimensional image is generated for identifying the arrangement and shape of a target object, on the basis of the concept of the virtual array according to the object detection apparatus 1000 described in the first embodiment. As such, in the present third embodiment too, the object detection apparatus includes the transmission unit 1091, the reception unit 1092, and the data processing unit 1093 illustrated in FIGS. 1 and 9. However, the present third embodiment differs from the first embodiment in terms of the number of reception units 1092. This will be described in detail below.

FIG. 14 is a diagram illustrating the configuration and principles of operation of the object detection apparatus according to the third embodiment of the present invention. FIG. 14 illustrates positional relationships between the antennas and the target object. First, in the object detection apparatus according to the present third embodiment, the reception antennas 1004 are arranged along N directions (where N equals 2, 3, . . . ), taking the transmission antenna 1003 of the transmission unit as a reference. Additionally, the data processing unit calculates the product of baseband signals generated by each of the plurality of reception units, and on the basis of the calculated product, detects the position of the target object 1001 in an N-dimensional coordinate space that takes the N directions as coordinate axes.

Specifically, the transmission antenna 1003 is arranged at a position corresponding to the origin of the coordinates, and a reception antenna 1004(x) and a reception antenna 1004(y) of the reception unit are arranged on the x axis and the y axis, respectively. In this case, N=2.

In the present third embodiment, it is desirable, from the standpoint of obtaining a two-dimensional image, that the direction connecting the transmission antenna 1003 with the reception antenna 1004(x) and the direction connecting the reception antenna 1004(y) with the transmission antenna 1003 be different directions (that is, not be parallel). Note, however, that it is not absolutely necessary that the direction connecting the transmission antenna 1003 with the reception antenna 1004(x) and the direction connecting the transmission antenna 1003 with the reception antenna 1004(y) be orthogonal to each other.

The RF signal (electric wave) 1010 from the transmission antenna 1003 is emitted toward the target object 1001 present on a focal plane 1002. After the RF signal 1010 has been emitted toward the target object 1001, a reflected wave 1007(x) and a reflected wave 1007(y) from the target object 1001 are received by the reception antenna 1004(x) and the reception antenna 1004(y), respectively. As in the first and second embodiments, the carrier frequency of the RF signal 1010 output by the transmission antenna 1003 changes continuously as time passes, in the present third embodiment as well.

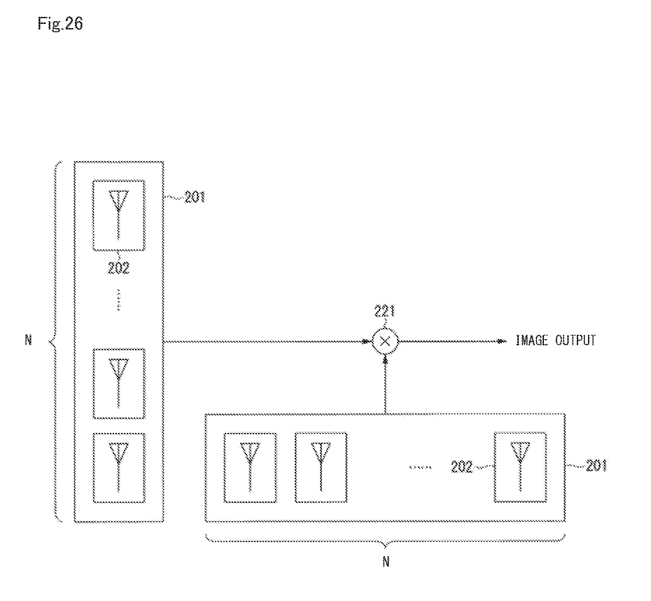

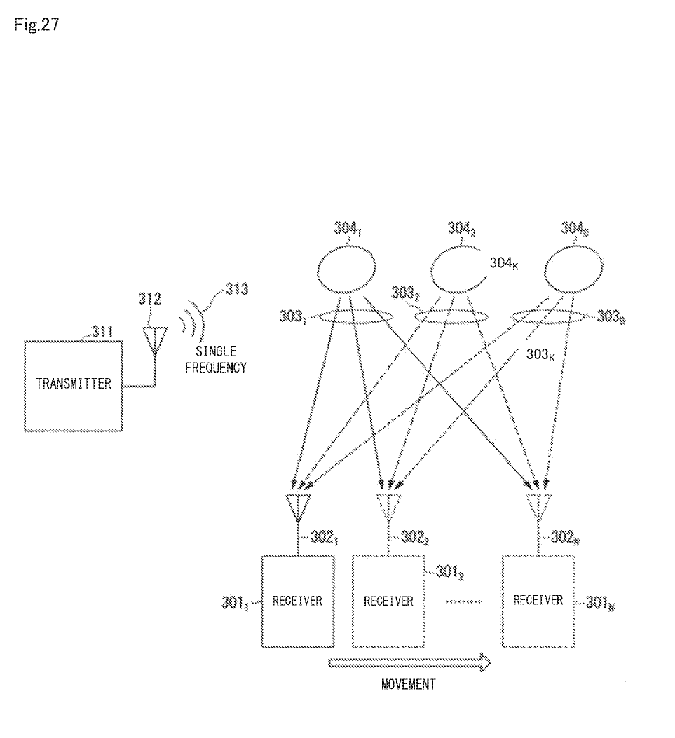

A goal of the third embodiment illustrated in FIG. 14 is converting two array antennas 201 according to the Mills Cross method illustrated in FIG. 26 into frequency-virtual arrays. Specifically, the two array antennas 201 according to the Mills Cross method illustrated in FIG. 27 are converted into a virtual array constituted by a combination of the transmission antenna 1003 and the reception antenna 1004(x), and a virtual array constituted by a combination of the transmission antenna 1003 and the reception antenna 1004(y). Thus in the present third embodiment, the minimum number of antennas required to generate a two-dimensional image is 3.

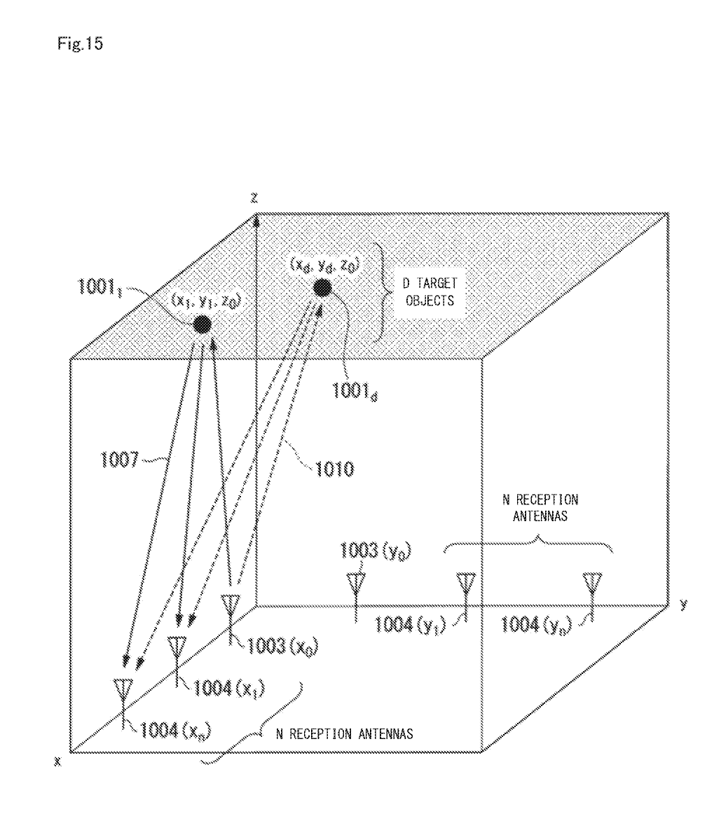

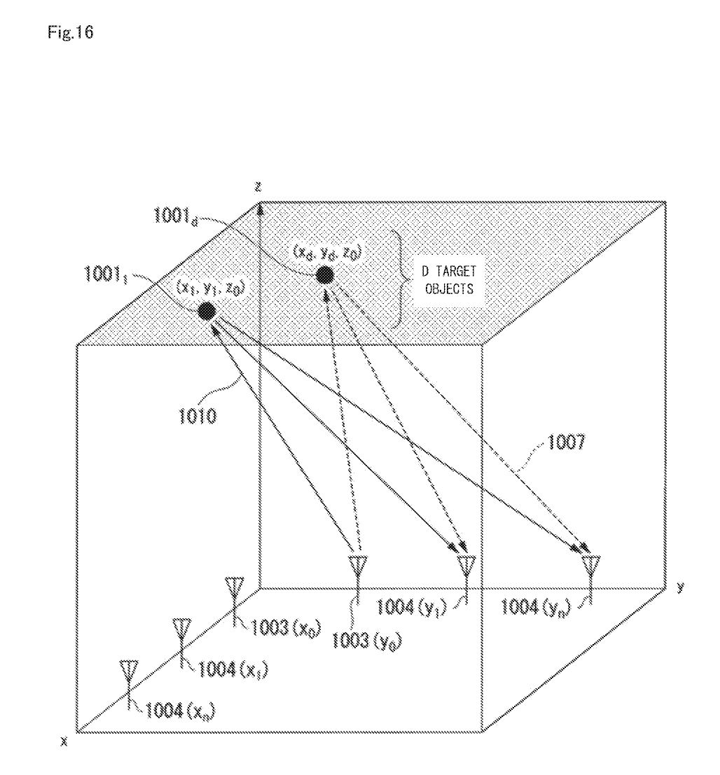

Details of the process through which the object detection apparatus according to the present third embodiment generates the two-dimensional image will be described next using FIGS. 15 and 16. FIGS. 15 and 16 are diagrams illustrating a method of calculating a correlation matrix of a two-dimensional frequency-virtual array according to the third embodiment of the present invention. FIGS. 15 and 16 illustrate a calculation model for analyzing the operations of generating the two-dimensional image.

As illustrated in FIGS. 15 and 16, with the calculation model according to the present third embodiment, one transmission antenna 1003(x₀) and N reception antennas 1004(x₁), . . . , 1004(x_{N}) are arranged on the x axis. Furthermore, with the calculation model according to the present third embodiment, one transmission antenna 1003(y₀) and N reception antennas 1004(y₁), . . . , 1004(y_{N}) are arranged on the y axis.

In xyz axis coordinates, the position of the transmission antenna 1003(x₀) on the x axis is represented by (dx₀,0,0), and the position of the nth reception antenna 1004(xₙ) is represented by (dxₙ,0,0). Likewise, the position of the transmission antenna 1003(y₀) on the y axis is represented by (0,dy₀,0), and the position of the nth reception antenna 1004(yₙ) is represented by (0,dyₙ,0).

It is also assumed that the target objects 1001 are arranged at D positions (x₁,y₁,z₀), (x₂,y₂,z₀), . . . , (x_{D},y_{D},z₀) on a plane where z=z₀. To simplify the descriptions, it is assumed that the positional relationship between the object detection apparatus (the transmission antenna 1003 and the reception antennas 1004) and the target object 1001 is fixed to the above-described positional relationship.

In terms of theoretical calculations, it is assumed that when the transmission antenna 1003(x₀) on the x axis is transmitting, only the reception antennas 1004(x₁), . . . , 1004(x_{N}) on the x axis are receiving, and when the transmission antenna 1003(y₀) on the y axis is transmitting, only the reception antennas 1004(y₁), . . . , 1004(y_{N}) on the y axis are receiving, as illustrated in FIG. 15.

Additionally, although the transmission antenna 1003(x₀) and the transmission antenna 1003(y₀) are arranged separately on the x axis and the y axis in the example illustrated in FIGS. 15 and 16, this is only to make the descriptions of the theory general. In actual practice, the transmission antenna 1003(x₀) and the transmission antenna 1003(y₀) may be constituted by the same transmission antenna, in which case when that single transmission antenna is transmitting, the reception antenna on the x axis and the reception antenna on the y axis may receive at the same time.

Additionally, as in the first and second embodiments, the transmission antenna 1003(x₀) and the transmission antenna 1003(y₀) transmit the RF signal 1010 at M carrier frequencies αt₁, αt₂, . . . , αt_{M}, in the present third embodiment as well. The RF signal 1010 is modulated using the above-described FM-CW method in the present third embodiment as well.

The complex amplitude of the RF signal 1007, which has been reflected by the target object 1001_{d} (where d=1, 2, . . . , D) and received by the nth reception antenna 1004(xₙ) on the x axis, at the sampling time tₘ, is assumed to be sₓₙ(x_{d},y_{d},tₘ). Additionally, the complex amplitude of the reception signal actually measured by the nth reception antenna 1004(xₙ) on the x axis (a combination of waves reflected from the targets) is assumed to be sₓ(tₘ). The relationship indicated by the following Expression (40) holds true between sₓₙ(tₘ) and sₓₙ(x_{d},y_{d},tₘ).

$$\begin{matrix}[ Expression 40 ] & \\ {s}_{xn} ( {t}_{m} ) = {\sum }_{d = 1}^{D} {s}_{xn} ( {x}_{d} , {y}_{d} , {t}_{m} ) , \\ ( n = 1 , 2 , … , N , m = 1 , 2 , … , M ) & ( 40 )\end{matrix}$$

Additionally, when signals s_{yn}(tₘ) and s_{yn}(x_{d},y_{d},tₘ) are likewise defined for the nth reception antenna 1004(yₙ) on the y axis, the same relationship as that indicated in Expression (29) holds true in this case as well, as indicated by the following Expression (41).

$$\begin{matrix}[ Expression 41 ] & \\ {s}_{yn} ( {t}_{m} ) = {\sum }_{d = 1}^{D} {s}_{yn} ( {x}_{d} , {y}_{d} , {t}_{m} ) , \\ ( n = 1 , 2 , … , N , m = 1 , 2 , … , M ) & ( 41 )\end{matrix}$$

A distance Lₓₒ(x_{d},y_{d}) between the target object 1001_{d} and the transmission antenna 1003(x₀) on the x axis is given by the following Expression (42). Additionally, a distance Lₓₙ(x_{d},y_{d}) between the target object 1001_{d} and the nth reception antenna 1004(x₀) on the x axis is given by the following Expression (43).

[Expression 42]

Lₓ₀(x_{d},y_{d})=\sqrt{(x_{d}−dₓ₀)²+y_{d}²+z₀²}, (42)

[Expression 43]

Lₓₙ(x_{d},y_{d})=\sqrt{(x_{d}−dₓₙ)²+y_{d}²+z₀²}, (43)

Assuming the distances of the transmission antenna 1003(y₀) and the nth reception antenna 1004(yₙ) on the y axis from the target 1001_{d} are L_{yo}(x_{d},y_{d}) and L_{yn}(x_{d},y_{d}), respectively, those distances are given by the following Expressions (44) and (45).

[Expression 44]

L_{y0}(x_{d},y_{d})=\sqrt{x_{d}²+(y_{d}−d_{y0})²+z₀²}, (44)

[Expression 45]

L_{yn}(x_{d},y_{d})=\sqrt{x_{d}²+(y_{d}−d_{yn})²+z₀²}, (45)

The relationship indicated by the following Expression (46) exists between a complex amplitude s₀ of the RF signal sent from the transmission antenna 1003(x₀) and a complex amplitude sₓ(x_{d},y_{d},tₘ) obtained from the RF signal received by the nth reception antenna 1004(xₙ) on the x axis.

$$\begin{matrix} [ Expression 46 ] & \\ {s}_{xn} ( {x}_{d} , {y}_{d} , {t}_{m} ) = {s}_{0} \cdot σ ( {x}_{d} , {y}_{d} ) exp [ - j \frac{2 π α {t}_{m}}{c} \{ {L}_{x 0} ( {x}_{d} , {y}_{d} ) + {L}_{xn} ( {x}_{d} , {y}_{d} ) \} ] , & ( 46 )\end{matrix}$$

In Expression (46), σ(x_{d},y_{d}) is an unknown number expressing the reflectance of the target object 1001_{d} (where d=1, 2, . . . , D). Additionally, the same relationship holds true for the reception antenna 1004(yₙ) on the y axis, as indicated by the following Expression (47).

$$\begin{matrix} [ Expression 47 ] & \\ {s}_{yn} ( {x}_{d} , {y}_{d} , {t}_{m} ) = {s}_{0} \cdot σ ( {x}_{d} , {y}_{d} ) exp [ - j \frac{2 π α {t}_{m}}{c} \{ {L}_{y 0} ( {x}_{d} , {y}_{d} ) + {L}_{yn} ( {x}_{d} , {y}_{d} ) \} ] , & ( 47 )\end{matrix}$$

The following Expression (48) is obtained by substituting Expression (47) in Expression (40), and the following Expression (49) is obtained by substituting Expression (48) in Expression (41).

$$\begin{matrix} [ Expression 48 ] & \\ {s}_{xn} ( {t}_{m} ) = {s}_{0} {\sum }_{d = 1}^{D} σ ( {x}_{d} , {y}_{d} ) exp [ - j \frac{2 π α {t}_{m}}{c} \{ {L}_{x 0} ( {x}_{d} , {y}_{d} ) + {L}_{xn} ( {x}_{d} , {y}_{d} ) \} ] , & ( 48 ) \\ [ Expression 49 ] & \\ {s}_{yn} ( {t}_{m} ) = {s}_{0} {\sum }_{d = 1}^{D} σ ( {x}_{d} , {y}_{d} ) exp [ - j \frac{2 π α {t}_{m}}{c} \{ {L}_{y 0} ( {x}_{d} , {y}_{d} ) + {L}_{yn} ( {x}_{d} , {y}_{d} ) \} ] , & ( 49 )\end{matrix}$$

Next, the measurement signal vector sₓ is defined as indicated by the following Expression (50), using a measurement signal sₓₙ(tₘ) at the nth reception antenna 1004(xₙ) (where n=1, 2, . . . , N) on the x axis.

[Expression 50]

sₓ≡[sₓ₁(t₁), . . . , sₓ₁(t_{M}), . . . , s_{xN}(t₁), . . . , s_{xN}(t_{M})]^{T}, (50)

The measurement signal at the reception antenna 1004(yₙ) (where n=1, 2, . . . , N) in the y axis direction is defined in the same manner, as indicated in the following Expression (51).

[Expression 51]

s_{y}≡[s_{y1}(t₁), . . . , s_{y1}(t_{M}), . . . , s_{yN}(t₁), . . . , s_{yN}(t_{M})]^{T}, (51)

A direct product vector s_{xy} indicated by the following Expression (52) is generated by calculating the product of all combinations of the element of the x axis direction measurement vector sₓ from the above-described Expression (50) and the element of the y axis direction measurement vector s_{y} from the above-described Expression (51), according to the Mills Cross method. Note that “product” here corresponds to the above-described “product of the baseband signals”.

$$\begin{matrix} [ Expression 52 ] & \\ {s}_{xy ( nv ) ( mw )} ≡ {s}_{xn} ( {t}_{m} ) {s}_{yv} ( {t}_{w} ) , ( n , v = 1 , 2 , … , N , m , w = 1 , 2 , … , M ) \\ {s}_{xy} ≡ ⌊ {s}_{xy ( 11 ) ( 11 )} , {s}_{xy ( 11 ) ( 12 )} , … , {s}_{xy ( 11 ) ( 1 M )} , … , {s}_{xy ( 11 ) ( M 1 )} , {s}_{xy ( 11 ) ( M 2 )} , … , {s}_{xy ( 11 ) ( MM )} , … , {s}_{xy ( 1 N ) ( 11 )} , {s}_{xy ( 1 N ) ( 12 )} , … , {s}_{xy ( 1 N ) ( 1 M )} , … , {s}_{xy ( 1 N ) ( M 1 )} , {s}_{xy ( 1 N ) ( M 2 )} , … , {s}_{xy ( 1 N ) ( MM )} , … , {s}_{xy ( NN ) ( 11 )} , {s}_{xy ( NN ) ( 12 )} , … , {s}_{xy ( NN ) ( 1 M )} , … , {s}_{xy ( NN ) ( M 1 )} , … , {s}_{xy ( NN ) ( M 1 )} , {s}_{xy ( NN ) ( M 2 )} , … , {s}_{xy ( NN ) ( MM )} ] T & ( 52 )\end{matrix}$$

In Expression (52), n and v are subscript indicating numbers of antennas arranged in the x direction and the y direction, whereas m and w are subscript expressing frequency numbers of signals received by the antennas arranged in the x direction and y direction, respectively. The direction matrix A is defined by the following Expression (53).

$$\begin{matrix} [ Expression 53 ] & \\ A ≡ ( \begin{matrix}{A}_{11} \\ {A}_{12} \\ ⋮ \\ {A}_{1 N} \\ ⋮ \\ {A}_{N 1} \\ ⋮ \\ {A}_{NN}\end{matrix} ) , \\ {A}_{mn} = ( {a}_{nv} ( {x}_{1} , {y}_{1} ) , {a}_{nv} ( {x}_{2} , {y}_{2} ) , … , {a}_{nv} ( {x}_{D} , {y}_{D} ) ) , \\ {a}_{nv} ( {x}_{d} , {y}_{d} ) = [ {a}_{d ( nv ) ( 11 )} , {a}_{d ( mv ) ( 12 )} , … , {a}_{d ( mv ) ( 1 M )} , … , {a}_{d ( nv ) ( M 1 )} , {a}_{d ( nv ) ( M 2 )} , … , {a}_{d ( nv ) ( MM )} ] T , \\ {a}_{d ( nv ) ( mw )} = exp [ - j \frac{2 π α {t}_{m}}{c} \{ {L}_{x 0} ( {x}_{d} , {y}_{d} ) + {L}_{xn} ( {x}_{d} , {y}_{d} ) \} - j \frac{2 π α {t}_{w}}{c} \{ {L}_{y 0} ( {x}_{d} , {y}_{d} ) + {L}_{yv} ( {x}_{d} , {y}_{d} ) \} ] , & ( 53 )\end{matrix}$$

In Expression (53), the size of the direction matrix A is (MN)2×D), the size of a matrix Aₙᵥ is M2×D, and the size of a vector aₙᵥ(x_{d},y_{d}) is M²×1. The matrix Aₙᵥ is a direction matrix involving the nth x direction antenna 1004(xₙ) and the with y direction antenna 1004(yᵥ). The direction matrix A of the system as a whole is a collection of all sets (n,v) of antenna numbers into a direction matrix Aₙᵥ.

Here, as in the above-described estimation of the one-dimensional incoming direction, the desired signal vector s is defined by the following Expression (54), using the complex amplitude s₀ and the reflectance σ(x_{d},y_{d}).

[Expression 54]

s≡s₀[σ(x₁,y₁), σ(x₂,y₂), . . . , σ(x_{D},y_{D})]^{T}, (54)

The relational expression indicated in the following Expression (55), between the measurement signal vector s_{xy}(t) of Expression (52), the direction matrix A of Expression (53), and the desired signal vector s of Expression (54), is obtained from Expressions (48) and (49). In Expression (55), a vector n(t) that takes noise (a random number) as an element is added.

[Expression 55]

s_{xy}=As+n(t), (55)

Next, a correlation matrix R_{xy} is calculated using the measurement signal vector s_{xy} of Expression (52), obtained through measurement. From the relationship in Expression (55), the relationship between the correlation matrix R_{xy} and the direction matrix A is given by the following Expression (56).

$$\begin{matrix} [ Expression 56 ] & \\ {R}_{xy} ≡ E ⌊ {s}_{xy} \cdot {s}_{xy}^{H} ⌋ = {ASA}^{H} + {P}_{N} I , \\ S ≡ {E [ s \cdot {s}^{H} ]}^{T} = {\vert {s}_{0} \vert}^{2} \cdot ( \begin{matrix}{\vert σ ( {x}_{1} ) \vert}^{2} & σ ( {x}_{1} ) {σ}^{*} ( {x}_{2} ) & … & σ ( {x}_{1} ) {σ}^{*} ( {x}_{D} ) \\ σ ( {x}_{2} ) {σ}^{*} ( {x}_{1} ) & {\vert σ ( {x}_{2} ) \vert}^{2} & & σ ( {x}_{2} ) {σ}^{*} ( {x}_{D} ) \\ ⋮ & ⋮ & & ⋮ \\ & & & \\ σ ( {x}_{D} ) {σ}^{*} ( {x}_{1} ) & σ ( {x}_{D} ) {σ}^{*} ( {x}_{2} ) & … & {\vert σ ( {x}_{D} ) \vert}^{2}\end{matrix} ) , & ( 56 )\end{matrix}$$

In Expression (56), P_{N} represents the average power of the noise term n(t), whereas I represents an (MN)²×(MN)² dimensional unit matrix. The size of the correlation matrix R_{xy}, the matrix A, and the matrix S are (MN)²×(MN)² dimensions, (MN)²×D dimensions, and D×D dimensions, respectively.

Expression (55) and Expression (56) have the same form as Expression (26) and Expression (28) in the one-dimensional incoming direction estimation discussed in the second embodiment. Accordingly, an evaluation function P_{MU}(x,y) reflecting σ(x_{d},y_{d}) can be calculated by applying the MUSIC method to the correlation matrix R_{xy} through the same sequence as in the one-dimensional incoming direction estimation.

However, as in the one-dimensional incoming direction estimation, the matrix A and the matrix S in Expression (56) being full rank is a condition for applying the MUSIC method. Also as described above, although the direction matrix A is full rank, the matrix S is not full rank when σ(xᵢ)=σ(xⱼ) (i≠j). It is therefore necessary to carry out processing so that the matrix S becomes full rank through the sub array method.

When generating a two-dimensional image as well, a single sub array is constructed with M frequencies, and a total of Q sub arrays are constructed, through the same sequence as in the sub array method used to estimate the one-dimensional incoming direction described in the second embodiment. Assuming the overall number of sampling times is M₀, a relationship of Q=M₀−M+1 holds true. The qth sub array signal is defined by the following Expression (57). The qth sub array signal corresponds to shifting the subscript m and w expressing the sampling time of a component s_{xy(nv,mw)} of a signal vector s_{xy} by +(q−1) places at the same time.

[Expression 57]

s_{xy}^{q}≡[s_{xy(N)(qq)}, s_{xy(N)(q,q+1)}, . . . , s_{xy(N)(q,M+q-1)}, . . . , s_{xy(N)(M+q-1,q)}, s_{xy(N)(M+q-1,q+1), . . . , s}_{xy(N)(M+q-1,M+q-1)}, s_{xy(1N)(qq)}, s_{xy(1N)(q,q+1)}, . . . , s_{xy(1N)(q,M+q-1)}, . . . , s_{xy(1N)(M+q-1,q)}, s_{xy(1N)(M+q-1,q+1)}, s_{xy(1N)(M+q-1,q-1)}, . . . , s_{xy(NN)(qq)}, s_{xy(NN)(q,q+1)}, . . . , s_{xy(NN)(q,M+q-1)}, . . . , s_{xy(NN)(M+1-1,q)}, s_{xy(NN)(M+q-1,q+1)}, s_{xy(NN)(M+q-1,M+q-1)}]^{T}, (57)

The relational expression indicated in the following Expression (58) is established between a sub array signal s_{xy}^{q} in Expression (57) and the direction matrix of Expression (42).

$$\begin{matrix} [ Expression 58 ] & \\ {s}_{xy}^{q} = ( \begin{matrix}{A}_{11} {B}_{11}^{q - 1} \\ {A}_{12} {B}_{12}^{q - 1} \\ ⋮ \\ {A}_{1 N} {B}_{1 N}^{q - 1} \\ ⋮ \\ {A}_{nv} {B}_{nv}^{q - 1} \\ ⋮ \\ {A}_{N 1} {B}_{N 1}^{q - 1} \\ ⋮ \\ {A}_{NN} {B}_{NN}^{q - 1}\end{matrix} ) s + n ( t ) , \\ {B}_{nv} ≡ \cdot ( \begin{matrix}{b}_{nv 1} & 0 & … & 0 \\ 0 & {b}_{mv 2} & & 0 \\ ⋮ & ⋮ & & ⋮ \\ & & & \\ 0 & 0 & … & {b}_{n D}\end{matrix} ) , \\ {b}_{nvd} = exp [ - j \frac{2 π α Δ t}{c} \{ {L}_{x 0} ( {x}_{d} , {y}_{d} ) + {L}_{xn} ( {x}_{d} , {y}_{d} ) \} - j \frac{2 π α Δ t}{c} \{ {L}_{y 0} ( {x}_{d} , {y}_{d} ) + {L}_{yv} ( {x}_{d} , {y}_{d} ) \} ] , & ( 58 )\end{matrix}$$

The correlation matrix Rₓ^{q} of the sub array q is calculated as indicated by the following Expression (59).

$$\begin{matrix}[ Expression 59 ] & \\ {R}_{xy}^{q} ≡ {E [ {s}_{xy}^{q} \cdot {s}_{xy}^{qH} ]}^{T} = {A}^{′} {S}^{′} {A}^{′ H} + {P}_{N} I , \\ {A}^{′} ≡ ( \begin{matrix}{A}_{11} & 0 & … & & & & … & 0 \\ 0 & {A}_{12} & & & & & & ⋮ \\ & & ⋱ & & & & & \\ & & & {A}_{1 N} & & & & \\ & & & & ⋱ & & & \\ & & & & & {A}_{N 1} & & ⋮ \\ ⋮ & & & & & & ⋱ & 0 \\ 0 & … & & & & … & 0 & {A}_{NN}\end{matrix} ) , \\ {S}^{′} ≡ ( \begin{matrix}{S}_{11}^{′} & {S}_{12}^{′} & … & {S}_{1 , N \hat{} 2}^{′} \\ {S}_{21}^{′} & {S}_{22}^{′} & … & {S}_{2 , N \hat{} 2}^{′} \\ ⋮ & ⋮ & & ⋮ \\ {S}_{N \hat{} 2 , 1}^{′} & {S}_{N \hat{} 2 , 2}^{′} & … & {S}_{N \hat{} 2 , N \hat{} 2}^{′}\end{matrix} ) , \\ {S}_{ij}^{′} ≡ {B}_{i}^{′ q - 1} {S ( {B}_{j}^{′ q - 1} )}^{H} , {B}_{i}^{′} ≡ {B}_{nv} , \\ ( i = v + ( n - 1 ) N , n , v = 1 , 2 , … , N , ) & ( 59 )\end{matrix}$$

In Expression (59), the sizes of the correlation matrix R_{xy}^{q}, the matrix A′, and the matrix S′ are (NM)²×(NM)² dimensions, (NM)²×N²D dimensions, and N²D×N²D dimensions, respectively. Next, an average R_{xy}′ of the correlation matrices of all the sub arrays q (where q=1, 2, . . . , Q) is calculated. A relationship between the average correlation matrix R_{xy}′ of all the sub arrays and the direction matrix A′ is calculated as indicated by the following Expression (60).

$$\begin{matrix}[ Expression 60 ] & \\ {R}_{xy}^{′} ≡ \frac{1}{Q} {\sum }_{q = 1}^{Q} {R}_{xy}^{q} = {A}^{′} {S}^{″} {A}^{′ H} ++ {P}_{N} I , \\ {S}^{″} ≡ ( \begin{matrix}{S}_{11}^{″} & {S}_{12}^{″} & … & {S}_{1 , N \hat{} 2}^{″} \\ {S}_{21}^{″} & {S}_{22}^{″} & … & {S}_{2 , N \hat{} 2}^{″} \\ ⋮ & ⋮ & & ⋮ \\ {S}_{N \hat{} 2 , 1}^{″} & {S}_{N \hat{} 2 , 2}^{″} & … & {S}_{N \hat{} 2 , N \hat{} 2}^{″}\end{matrix} ) , \\ {S}_{ij}^{″`} ≡ \frac{1}{Q} {\sum }_{q = 1}^{Q} {B}_{i}^{′ q - 1} {S ( {B}_{i}^{′ q - 1} )}^{H} , & ( 60 )\end{matrix}$$

The following items hold true, in the same manner as with the estimation of the one-dimensional incoming direction described above in the second embodiment.
(1) If the matrices A′ and S″ are full rank, the evaluation function P_{MU}(x,y) reflecting σ(x_{d},y_{d}) can be calculated by applying the MUSIC method to the correlation matrix R_{xy}′.
(2) With respect to the matrix A′, the direction matrices A₁₁, A₁₂, . . . , A_{1N}, . . . , A_{N1}, . . . , A_{NN} are both independent and full rank, and thus A′ as given by Expression (59) is also full rank.
(3) The matrix S″ is full rank when Q≥D. The condition MN≥D+1 for applying the MUSIC method in the estimation of the one-dimensional incoming direction becomes (MN)²≥D+1 when generating a two-dimensional image. Taking this into account along with the conditions Q=M₀−M+1 and Q≥D for sub arrays, the conditions for the necessary number of sampling times (number of frequencies) M₀ is given by the following Expression (61). In other words, the necessary number of sampling times M₀ increases substantially proportional to the number of positions D to be detected.

$$\begin{matrix}[ Expression 61 ] & \\ {M}_{0} \geq D - 1 + \frac{\sqrt{D + 1}}{N} \approx ( 1 + \frac{1}{N \sqrt{D}} ) D , & ( 61 )\end{matrix}$$

Next, the evaluation function P_{MU}(x,y) reflecting σ(x_{d},y_{d}) is calculated by applying the MUSIC method to the average correlation matrix R_{xy}′ of all sub arrays, calculated through Expression (60). The evaluation function indicated in the following Expression (62) is obtained as a result.

$$\begin{matrix}[ Expression 62 ] & \\ {P}_{MU} ( x , y ) = \frac{{a}^{H} ( x , y ) a ( x , y )}{{a}^{H} ( x , y ) {E}_{N} {E}_{N}^{H} a ( x , y )} , & ( 62 )\end{matrix}$$

Here, a(x,y) is a column vector of the direction matrix A defined in Expression (42). E_{N} is given by the following Expression (63).

[Expression 63]

E_{N}≡[e_{D+1}, e_{D+2}, . . . , e_{(MN)̂2}], (63)

Here, among the eigenvectors of the correlation matrix R_{sxy}′, the eigenvalues of the vector eₖ (where k=D+1, D+2, . . . , (MN)²) are equal to the noise power.

The evaluation function P_{MU}(x,y) gives a peak at the position (x_{d},y_{d}) (where d=1, 2, . . . , D) of the target object 1001_{d}. Accordingly, the position information (x_{d},y_{d}) (where d=1, 2, . . . , D) of the target object 1001_{d} can be detected from the evaluation function P_{MU}(x,y), and the distribution and shape of the target object 1001 can be detected therefrom.

Although the position of the target object 1001_{d} (where d=1, 2, . . . , D) is detected using the MUSIC method above, it is also possible to calculate an evaluation function by applying the beam former method, the Capon method, and the linear prediction method (described in Non-Patent Document 1 as the same method as formally applied to a typical array antenna) to the correlation matrix R_{sxy}′.

Taking the above into account, an evaluation function P_{BF}(x,y) based on the beam former method according to the present third embodiment is given by the following Expression (64).

$$\begin{matrix}[ Expression 64 ] & \\ {P}_{BF} ( x , y ) = \frac{{a}^{H} ( x , y ) {R}_{sxy}^{′} a ( x , y )}{{a}^{H} ( x , y ) a ( x , y )} , & ( 64 )\end{matrix}$$

Furthermore, an evaluation function PCP(x,y) based on the Capon method according to the present third embodiment is given by the following Expression (65).

$$\begin{matrix}[ Expression 65 ] & \\ {P}_{CP} ( x , y ) = \frac{1}{{a}^{H} ( x , y ) {R}_{sxy}^{′ - 1} a ( x , y )} , & ( 65 )\end{matrix}$$

Further still, an evaluation function PLP(x,y) based on the linear prediction method according to the present third embodiment is given by the following Expression (66).

$$\begin{matrix}[ Expression 66 ] & □ \\ {P}_{LP} ( x , y ) ≡ \frac{1}{{\vert {W}_{LP}^{H} a ( x , y ) \vert}^{2}} , \\ {W}_{LP} ≡ {R}_{sxy}^{′ - 1} T , T ≡ {[ 1 , 0 , … , 0 ]}^{T} , & ( 66 )\end{matrix}$$

The above-described evaluation functions P_{BF}(x,y), P_{CP}(x,y), and P_{LP}(x,y) also take on peak values at the position (x_{d},y_{d}) of the target object 1001_{d} (where d=1, 2, . . . , D), in the same manner as the evaluation function P_{MU}(x,y) obtained through the MUSIC method. Accordingly, the position x_{d} of the target object 1001_{d} (where d=1, 2, . . . , D) can be determined from the position (x,y) at which the evaluation function gives a peak value.

The process disclosed in the present third embodiment, i.e., the process of calculating the evaluation function from the result of measuring the reflected wave and determining the position of the target object from the evaluation function, is executed by the data processing unit 1093 illustrated in FIG. 9, in the same manner as in the second embodiment. The process of calculating the evaluation function in the present third embodiment and searching for the peak of the evaluation function is performed by controlling the phase shifter 1031 and the adder 1032 in the first embodiment, and corresponds to a process of searching for the beam direction where the reception signal intensity is maximum.

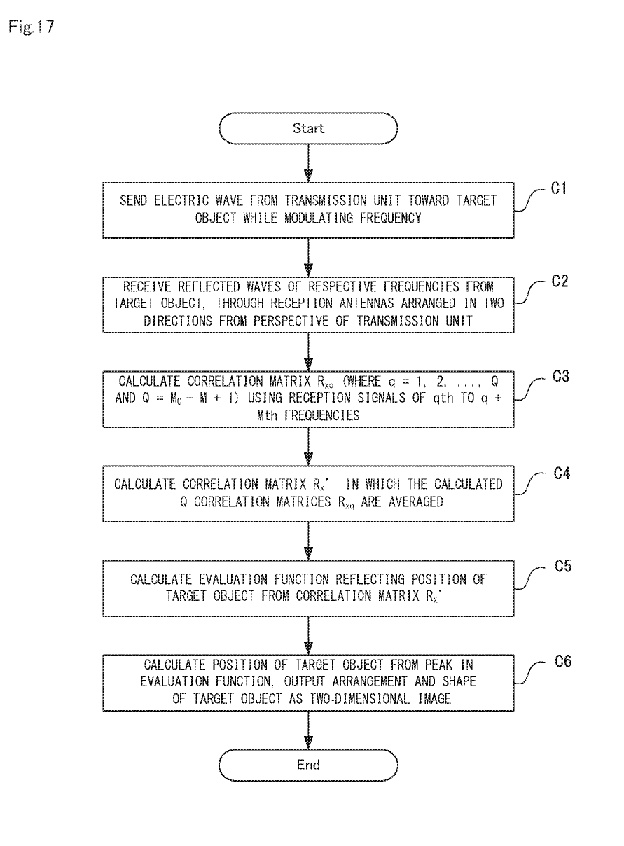

Next, the operations of the object detection apparatus according to the present third embodiment will be described using FIG. 17. FIG. 17 is a flowchart illustrating operations of the object detection apparatus according to the third embodiment of the present invention. In the present third embodiment, an object detection method is realized by causing the object detection apparatus to operate. As such, the following descriptions of the operations of the object detection apparatus 1000 will be given in place of descriptions of the object detection method according to the present third embodiment.

As illustrated in FIG. 17, first, in the object detection apparatus, the transmission unit emits an electric wave toward the target object while varying the RF carrier frequency (step C1).

Next, the plurality of reception units receive the reflected waves from the target object, through the corresponding reception antennas (step C2). The reception antennas are arranged in two directions from the perspective of the transmission unit.

Next, the data processing unit calculates the correlation matrix R_{xy}^{q} (where q=1, 2, . . . , Q and Q=M₀−M+1) using the reception signals from the qth to the q+Mth sampling times (step C3).

Next, the data processing unit calculates the correlation matrix R_{xy}′ in which the calculated Q correlation matrices R_{xy}^{q} (where q=1, 2, . . . , Q) are averaged (step C4), and furthermore calculates the evaluation function reflecting the position of the target object 1001 from the correlation matrix R_{xy}′ (step C5).

Then, the data processing unit calculates the position of the target object from the peak in the evaluation function, and furthermore outputs the arrangement and shape of the target object as a two-dimensional image to the output unit (step C6).

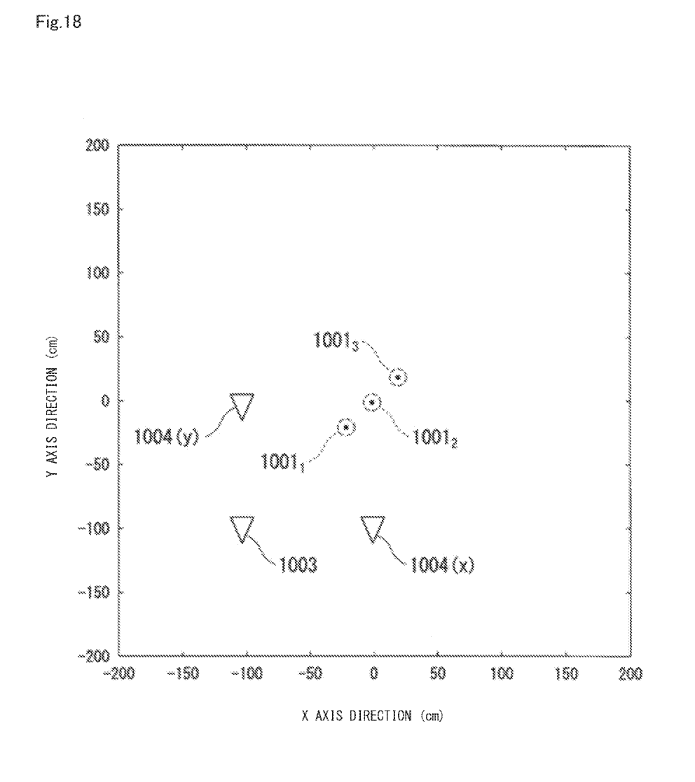

Next, an example of the two-dimensional image obtained by the object detection apparatus according to the present third embodiment will be described using FIG. 18. FIG. 18 is a diagram illustrating an example of an image output from the object detection apparatus according to the third embodiment of the present invention.

In the example of FIG. 18, the target objects 1001 are arranged at three locations in an (x,y,z) coordinate display, namely at (−20 cm, −20 cm, 100 cm), (0 cm, 0 cm, 100 cm), and (20 cm, 20 cm, 100 cm).

The transmission antenna 1003 is arranged at a location (−100 cm, −100 cm, 0 cm). It is assumed that the reception antennas 1004 are arranged at a position (0 cm, −100 cm, 0 cm) and a position (−100 cm, 0 cm, 0 cm).

Furthermore, it is assumed that the transmission antenna 1003 emits an RF signal 1010, to which is applied FM-CW modulation that varies the carrier frequency between 76 GHz and 81 GHz (for a bandwidth BW of 5 GHz), toward the target objects 1001. It is also assumed that the number of sampling times (the total number of frequencies) M₀ in a single chirp period (T_{chirp}) is 21, that the number Q of sub arrays is 10, and that the number (number of frequencies) M per sub array is 12. The sampling period Δt and the sampling time frequency change rate α are set so that αΔt=250 MHz. Under such conditions, the target objects 1001 arranged at the three locations are actually detected, as illustrated in FIG. 18. Each of the target objects 1001 is displayed in the two-dimensional image.

Although the example illustrated in FIGS. 14 to 18 indicates a case where the reception antennas are arranged in two directions (N=2), the present third embodiment can also be applied in a case where the reception antennas are arranged in three or more directions (N=3). In particular, the position of a target object in a three-dimensional space can be identified if the reception antennas are arranged in three orthogonal directions.

### Fourth Embodiment

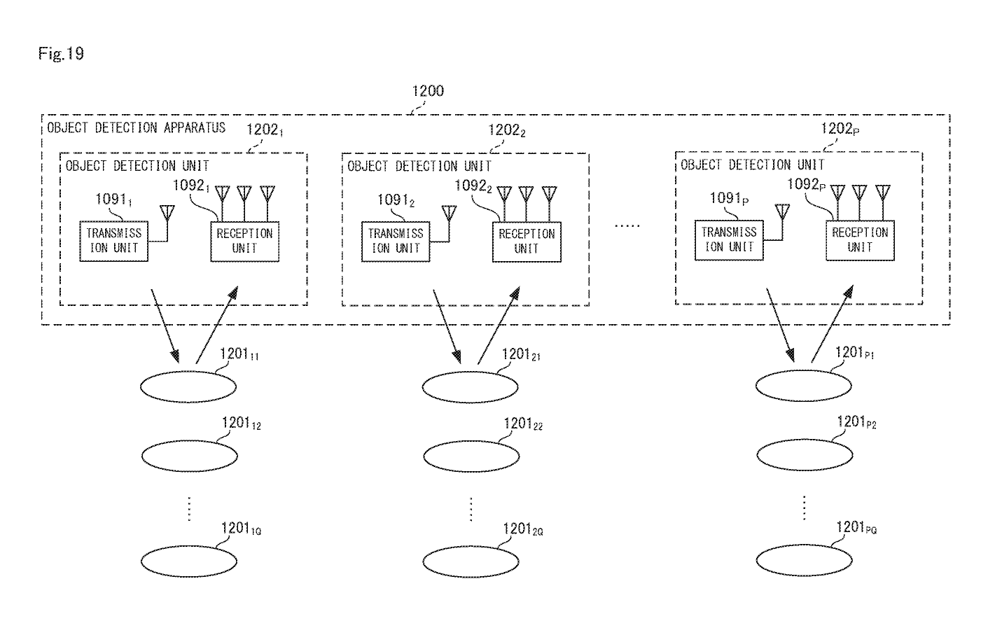

An object detection apparatus and an object detection method according to a fourth embodiment of the present invention will be described next, with reference to FIGS. 19 to 21.

FIG. 19 is a diagram illustrating the overall configuration of the object detection apparatus according to the fourth embodiment of the present invention. As illustrated in FIG. 18, in the present fourth embodiment, an object detection apparatus 1200 includes a plurality of object detection units 1202ₚ (where p=1, 2, . . . , P). Each of the object detection units 1202ₚ (where p=1, 2, . . . , P) includes a combination of a transmission unit 1091ₚ and a reception unit 1092ₚ. Here, P represents the number of object detection units 1202.

In the object detection units 1202ₚ, the transmission unit 1091ₚ emits an electric wave toward target objects 1201ₚ₁, 1201ₚ₂, . . . , 1201_{pQ}, and the reception unit 1092ₚ receives reflected waves from the target objects 1201ₚ₁, 1201ₚ₂, . . . , 1201_{pQ}. The state of the target objects 1201ₚ₁, 1201ₚ₂, . . . , 1201_{pQ} is detected as a result. Q represents the number of the target objects 1201.

When the target objects 1201ₚ₁, 1201ₚ₂, . . . , 1201_{pQ} are people, the object detection apparatus 1200 can use electric waves that penetrate the clothing worn by the people (1201ₚ₁, 1201ₚ₂, . . . , 1201_{pQ}) to detect the presence of items underneath the clothing.

Furthermore, if the target objects 1201ₚ₁, 1201ₚ₂, . . . , 1201_{pQ} are objects (and particularly, dielectric bodies), the object detection apparatus 1200 can use electric waves that penetrate the objects (1201ₚ₁, 1201ₚ₂, . . . , 1201_{pQ}) to detect the internal structures of the objects (1201ₚ₁, 1201ₚ₂, . . . , 1201_{pQ}).

If the target objects are objects on an assembly line, the object detection apparatus 1200 can use the object detection units 1202ₚ to detect the states of the target objects 1201ₚ₁, 1201ₚ₂, . . . , 1201_{pQ} in order.

In the example illustrated in FIG. 19, a single object detection unit 1202ₚ is assigned to detect or inspect a single target object 1201. However, the present fourth embodiment is not limited thereto, and a plurality of the object detection units 1202ₚ may be assigned to detect or inspect a single target object 1201. Additionally, in the present fourth embodiment, a single object detection unit 1202ₚ may be assigned to detect or inspect a plurality of the target objects 1201.

In this manner, according to the present embodiment, the object detection units 1202 can achieve compact sizes and low cost, which makes it possible to easily increase the number P of the object detection units 1202. Accordingly, in the object detection apparatus 1200 indicated in the example illustrated in FIG. 19, the speed at which the target objects 1201ₚ₁, 1201ₚ₂, . . . , 1201_{pQ} (where p=1, 2, . . . , P) are inspected can be increased in proportion to the number P of the object detection units 1202.

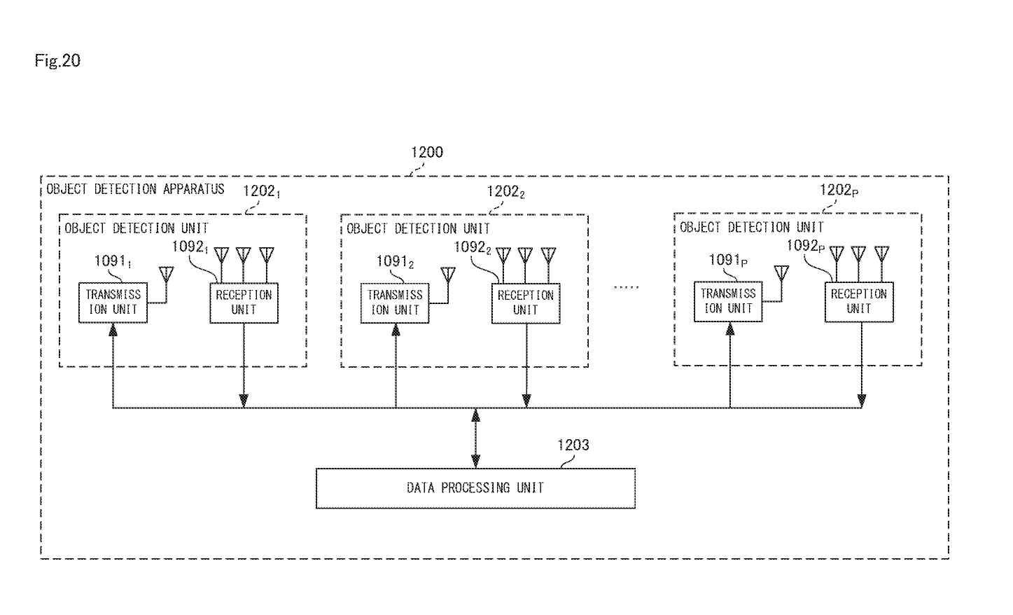

Incidentally, in the object detection apparatus 1200 illustrated in FIG. 19, erroneous operations may arise due to interference between the object detection units 1202ₚ (where P=1, 2, . . . , P). In other words, an electric wave from the transmission unit 1091ₚ wrapping around to a reception unit 1092ᵣ (p≠r) is a cause of interference that produces such erroneous operations. A configuration and operations that avoid such a problem will be described using FIG. 20.

FIG. 20 is a block diagram illustrating in detail the configuration of an object detection apparatus according to the fourth embodiment of the present invention. As illustrated in FIG. 20, in the present fourth embodiment, the object detection apparatus 1200 includes a data control unit 1203 in addition to the plurality of object detection units 1200ₚ. The data control unit 1203 controls the transmission unit 1091ₚ and the reception unit 1092ₚ that constitutes each of the object detection units 1202ₚ (where p=1,2, . . . , P). Specifically, the data control unit 1203 carries out, on each of the object detection units 1202ₚ, similar processing to that of the data control unit 1093 described in the first to third embodiments.

Additionally, the data control unit 1203 causes the object detection units to operate so that the frequency of the electric wave used is different for each of the object detection units. Specifically, the data control-unit 1203 carries out control so that an RF frequency fₚ of the object detection unit 1202ₚ and an RF frequency fᵣ of an object detection unit 1202ᵣ are different values (where p, r=1, 2, . . . , P, and p≠r). As a result of such control, the mutually-different object detection unit 1202ₚ and object detection unit 1202ᵣ (p≠r) operate at different RF frequencies. The occurrence of interference between the object detection unit 1202ₚ and the object detection unit 1202ᵣ (p≠r) is thus suppressed.

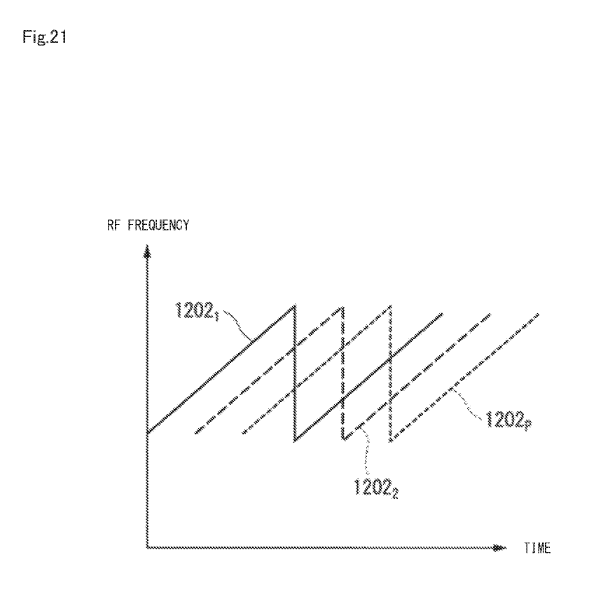

The control of the RF frequencies in the object detection units 1202ₚ (where p=1, 2, . . . , P) will be described here using FIG. 21. FIG. 21 is a diagram illustrating an example of frequency control carried out according to the fourth embodiment of the present invention.

As illustrated in FIG. 3, in the object detection units 1202ₚ (where p=1, 2, . . . , P), the carrier frequency (RF frequency) f changes continuously from fₘᵢₙ to fₘₐₓ in the sampling times t₁, t₂, . . . , t_{M} in the present fourth embodiment as well, in the same manner as in the first to third embodiments. In other words, in the object detection units 1202ₚ, the timewise variation in the RF frequency is controlled in chirps.

As illustrated in FIG. 21, in the present fourth embodiment, the data control unit 1203 carries out control so that the timewise variation in the RF frequencies of the object detection units 1202ₚ are shifted from each other. As a result, the mutually-different object detection unit 1202ₚ and object detection unit 1202ᵣ (p≠r) do not operate at the same RF frequency.

In this manner, according to the present fourth embodiment, functioning as the above-described data processing unit, control is carried out for the object detection units 1202ₚ so that the RF frequencies of the object detection units 1202ₚ are different. Specifically, the data control unit 1203 executes steps A1 to A5 illustrated in FIG. 10, and at that time, sets a different αtₘ for each object detection unit in step A2.

### Effects of Embodiment

The following is a summary of the effects of the present embodiment. Comparing the typical array antenna method with the first to fourth embodiments, the array antenna method requires a large number of antennas. On the other hand, according to the first to fourth embodiments, the number of virtual antennas can be increased by increasing the number of frequencies, rather than increasing the actual number of antennas. As a result, according to the embodiment, a function equivalent to a typical array antenna method can be realized with at least a single transmission antenna and a single reception antenna for each direction, which makes it possible to greatly reduce the actual number of antennas compared to a typical array antenna method.

When a synthetic aperture radar method is compared with the embodiment, the synthetic aperture radar method requires that the receiver be moved mechanically, which is problematic in that it takes a longer time to detect and inspect an object. On the other hand, according to the embodiment, it is sufficient to electronically scan the reception frequency rather than the position of the receiver, which makes it possible to reduce the time required to detect and inspect an object, as compared to the synthetic aperture radar method.

In other words, with the object detection apparatus and the object detection method according to the embodiment, the necessary number of antennas and the number of accompanying receivers can be reduced as compared to a typical array antenna method, which provides an effect in that the cost, size, and weight of the apparatus can be reduced. Additionally, with the object detection apparatus and object detection method according to the embodiment, the apparatus does not need to be mechanically moved as is the case with a typical synthetic aperture radar method, which also provides an effect in that it takes less time to detect and inspect an object.

In the embodiments, electric waves having RF frequencies that are different for each sampling time are emitted toward the object to be detected, and by detecting the electric waves reflected by the object, or detecting electric waves emitted from the object, an image of the object to be detected can be generated. Thus, according to the embodiments, the number of antennas and reception units required can be reduced as compared to conventional techniques, and an image can be generated through high-speed scanning without requiring any movement.

While the present invention has been described above with reference to embodiments, the present invention is not intended to be limited to the above embodiments.

The content disclosed in the above-described Patent Documents and so on can be incorporated into the present application by reference. Many changes and variations on the embodiments are possible on the basis of that basic technical spirit, without departing from the scope of the overall disclosure of the present application (including the scope of the patent claims). Additionally, various elements disclosed can be combined or selected in a variety of ways without departing from the scope of the patent claims of the present application. In other words, the present application includes various modifications and variations that can be carried out by one skilled in the art according to the overall disclosure and technical spirit including the scope of the patent claims.

### INDUSTRIAL APPLICABILITY

According to the present invention as described above, an increase in the apparatus cost, size, and weight can be suppressed while improving the accuracy when detecting an object using an electric wave. The present invention is useful when creating an image of an item concealed under clothing, an item in a bag, or the like for inspection.

### DESCRIPTION OF REFERENCE NUMERALS

1000 object detection apparatus

1001, 1201 target object (object to be detected)

1002 focal plane

1003 transmission antenna

1004 reception antenna

1007, 1010 electric wave (RF signal)

1041 low-noise amplifier

1042 mixer

1043 filter

1044 analog-digital converter

1075 coupler

1091 transmission unit

1092 reception unit

1093 data reception unit

1094 output unit

1103 oscillator

1102 reception control unit

1104 transmission control unit

1202 object detection unit

1200 object detection apparatus (fourth embodiment)

1203 data controunit

What is claimed is:

1. An object detection apparatus for detecting an object using an electric wave, the apparatus comprising:
a transmission unit that emits, as a transmission signal, an electric wave having a frequency that continuously changes over time;
a reception unit that acquires the transmission signal, receives the electric wave from the object as a reception signal, and furthermore generates a baseband signal by mixing the acquired transmission signal with the received reception signal; and
a data processing unit that estimates an incoming direction of the electric wave on the basis of a measurement value of the baseband signal for each of sampling times, identifies an intensity distribution of the electric wave on the basis of the estimated incoming direction of the electric wave, and detects the object on the basis of the identified intensity distribution.

2. The object detection apparatus according to claim 1,
wherein the reception unit includes a mixer connected to the transmission unit and the filter, and generates the baseband signal by mixing the acquired transmission signal with the reception signal using the mixer and using the filter to remove a component aside from a desired frequency of the signal obtained from the mixing.

3. The object detection apparatus according to claim 1,
wherein the transmission unit includes a transmission antenna;
the reception unit includes a reception antenna arranged along one direction taking the transmission antenna as a reference; and
the data processing unit detects a position of the object in the one direction on the basis of the intensity distribution.

4. The object detection apparatus according to claim 1,
wherein the transmission unit includes a transmission antenna;
a plurality of the reception units are provided, and each reception unit includes a reception antenna;
the reception antennas are arranged along N directions taking the transmission antenna as a reference; and
the data processing unit calculates a product of the baseband signals generated by each of the plurality of reception units, and on the basis of the calculated products, detects the position of the object in an N-dimensional coordinate space that takes the N directions as coordinate axes.

5. The object detection apparatus according to claim 1,
wherein the data processing unit calculates a correlation matrix from the measurement values of the baseband signals in each of the sampling times, furthermore finds an evaluation function that reflects the position of the object from the correlation matrix, and generates an image of the object from the evaluation function that has been found.

6. The object detection apparatus according to claim 5,
wherein on the basis of the measurement values of the baseband signals having different ranges for the sampling times, the data processing unit calculates the correlation matrix corresponding to the ranges of the sampling times, furthermore calculates an average value of the correlation matrix corresponding to the ranges of the sampling times, furthermore finds an evaluation function reflecting the position of the object on the basis of the average value of the correlation matrix, and generates an image of the object from the evaluation function that has been found.

7. The object detection apparatus according to claim 5,
wherein the data processing unit adds noise to the measurement value of the baseband signal for each of the sampling times, and calculates the correlation matrix from a signal obtained by adding the noise to the measurement value of the baseband signal.

8. The object detection apparatus according to claim 1,
wherein in the transmission unit, a time length of a transmitted signal or a number of the sampling times is selected in accordance with a ratio between a pre-set visible region and a resolution, or in accordance with a pre-set number of pixels.

9. The object detection apparatus according to claim 1,
wherein a plurality of the transmission units and the reception units are provided;
a set constituted by at least one of the transmission units and at least one of the reception units constitutes an object detection unit; and
the data processing unit causes each of the object detection units to operate so that the frequency of the electric wave is different for each object detection unit.

10. A method of detecting an object using an electric wave, the method comprising:
(a) a step of a transmitter emitting, as a transmission signal, an electric wave having a frequency that continuously changes over time;
(b) a step of a receiver acquiring the transmission signal, receiving the electric wave from the object as a reception signal, and furthermore generating a baseband signal by adding the acquired transmission signal to the received reception signal; and
(c) a step of a data processing apparatus estimating an incoming direction of the electric wave on the basis of a measurement value of the baseband signal for each of sampling times, identifying an intensity distribution of the electric wave on the basis of the estimated incoming direction of the electric wave, and detecting the object on the basis of the identified intensity distribution.
